(19) United States
(12) Patent Application Publication
(10) Pub. No.: US 2026/0297246 A1
(43) Pub. Date: Oct. 1, 2026

(54) LACTONE-BASED VITRIMERS

(71) Applicant: Georgia Tech Research Corporation, Atalnta, GA (US)

(72) Inventors: Hang QI, Atlanta, GA (US); Liang YUE, Atlanta, GA (US)

(21) Appl. No.: 19/478,467

(22) PCT Filed: Apr. 24, 2024
(86) PCT No.: PCT/US2024/025980

§ 371 Date: Oct. 24, 2025

Related U.S. Application Data
(60) Provisional application No. 63/497,838, filed on Apr. 24, 2023.

(51) Int. Cl. C08G 63/08; C08G 63/91

(52) U.S. Cl. CPC C08G 63/08; C08G 63/912

(57) ABSTRACT

The present disclosure provides polymers comprising one or more constitutional units derived from a polyol, and one or more constitutional units derived from an optionally substituted lactone, wherein the polymer is at least partially crosslinked. Articles formed from the polymers and methods of manufacturing said polymers are also provided.

### CROSS-REFERENCE TO RELATED APPLICATIONS

This application claims the benefit of priority to U.S. Provisional Application No. 63/497,838 filed Apr. 24, 2023, the disclosure of which is incorporated herein by reference in its entirety.

### STATEMENT REGARDING FEDERALLY SPONSORED RESEARCH OR DEVELOPMENT

This invention was made with government support under grant number N00014-20-1-2586, awarded by the Office of Naval Research. The government has certain rights in the invention.

### BACKGROUND

Petroleum-derived synthetic polymers are one of the most important technological advancements in recent human history and have become increasingly dominant in modern industry, bringing enormous benefits to our quality of life. However, the excessive use of these plastics also leads to increasing concerns about our environment and sustainability¹⁻³. Massive non-degradable and non-recyclable plastic waste now creates severe pollution both on land and in the oceans, and extensive efforts have been made to mitigate the environmental impact^{1,4}. New innovations in polymer science are urgently needed to create renewable, degradable alternatives with the competing performance of existing non-recyclable polymers^{5,6}.

Covalent adaptable network (CAN) polymers, or vitrimers, have recently emerged as potential sustainable replacements for conventional thermosets^{7,8}. Vitrimers have cross-linked networks with dynamic covalent linkages that enable thermal malleability and reprocessability while maintaining the integrity of the crosslinked network⁹⁻²⁰. However, just like thermoplastic reprocessing, performance deterioration is unavoidable after multiple cycles of reprocessing due to chain scission, degradation, and oxidation²¹⁻²⁴. Depolymerizing the vitrimer back to the original feedstocks could be an attractive strategy to enable the “monomer-polymer-monomer” closed-loop cycle, but it is challenging to achieve. In some instances, vitrimers have been shown to degrade into oligomers and small molecules. Still, these examples often involve harsh conditions, poor monomer recovery selectivity, and tedious separation processing before reusing, which could diminish the value of end-of-life vitrimers²⁵⁻³¹.

One pathway to achieve efficient depolymerization is to use monomers with low to moderate ceiling temperatures. Ceiling temperature (T_{c}) is a thermodynamic concept and is defined as the temperature where the rates of polymerization and depolymerization are equal. Above T_{c}, the polymer displays a tendency to depolymerize³²⁻³⁴. Many aliphatic polyesters from ring opening transesterification polymerization (ROTP) of cyclic lactones have been reported to possess low ceiling temperatures^{35,36}. Bulk ROTP of lactone monomers is a well-studied reaction to synthesize aliphatic polyesters. It is atom economical and solvent-free, and can be performed at room temperature or below, thereby reducing energy consumption compared with most other petroleum-based polymer feedstocks. It also has very well-controlled polymerization in which the molecular architecture and molecular weight can be easily adjusted by altering the initiator type and its ratio to the monomers.

Cyclic lactones widely exist in nature, and many have five (γ)- or six-membered (δ) rings. These bio-derived lactones are often used in the food and fragrance industry as additives due to their pleasant aroma. Additionally, these ring sizes generate polymers that are capable of depolymerizing to pristine monomers under mild conditions. Several alkyl substituted δ-valerolactone (δ-lactones) monomers have been reported as ROTP monomers, presenting ceiling temperature between 100 to 200° C., a preferable depolymerization temperature range that satisfies the application at ambient conditions while enabling depolymerizing in a relatively low temperature³⁵. However, unlike semicrystalline polycaprolactone, racemic poly(δ-lactone)s are amorphous viscous liquids with high flexibility due to the substituted alkyl side chain^{37,28}. Therefore, they can only be used as soft polyester segment precursors to prepare block polymers or polyurethanes³⁹⁻⁴². With different non-depolymerizable compositions added, those reported soft elastomers have limited depolymerizability.

### SUMMARY

The present disclosure provides polymer compositions, articles formed from said polymer compositions and methods of manufacturing said polymer compositions. The disclosed polymer compositions are crosslinked thermosets that have comparable performance to polydimethylsiloxane (PDMS) while providing the advantageous properties of vitrimers, such as welding and healing, reprocessing, and reshaping, which are otherwise not available for PDMS materials.

In one aspect, a polymer is provided. In some aspects, the polymer comprises one or more constitutional units derived from a polyol. In further aspects, the polymer comprises one or more constitutional units derived from an optionally substituted lactone. In even further aspects, the polymer is at least partially crosslinked. In some aspects, the polymer is a vitrimer.

In some aspects, the one or more constitutional units derived from a polyol comprise a structure of Formula (I):

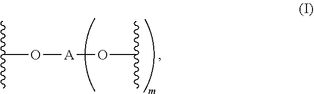

wherein all variables are as defined herein.

In some aspects, one or more constitutional units derived from an optionally substituted lactone comprise a structure of Formula (II):

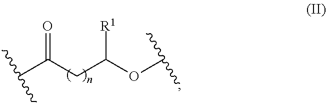

wherein all variables are as defined herein.

In some aspects, the one or more constitutional units derived from a polyol and the one or more constitutional units derived from an optionally substituted lactone are directly connected.

In some aspects, the polymer comprises one or more constitutional units having the structure:

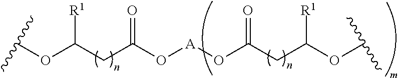

wherein all variables are as defined herein.

In some aspects, the polymer further comprises one or more crosslinking units derived from the divinyl ether.

In some aspects, the one or more crosslinking units comprise a structure of Formula (III):

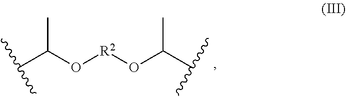

wherein all variables are as defined herein.

In another aspect, a polymer is provided formed from one or more monomers comprising a polyol and one or more monomers comprising an optionally substituted lactone. In some aspects, the polymer is at least partially crosslinked. In some aspects, the polymer is a vitrimer.

In some aspects, the one or more monomers comprising a polyol comprise a compound of Formula (I-a):

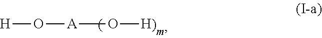

wherein all variables are as defined herein.

In some aspects, the one or more monomers comprising an optionally substituted lactone comprise a compound of Formula (II-a):

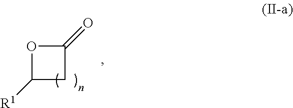

wherein all variables are as defined herein.

In some aspects, the polymer is at least partially crosslinked with a divinyl ether.

In some aspects, the divinyl ether comprises a compound of Formula (III-a):

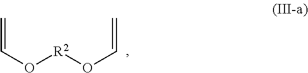

wherein all variables are as defined herein.

In another aspect, an article is provided comprising a polymer described herein. In some aspects, the article is a lens, a soft actuator, a sensor, a microfluidic chip, or a moldable article.

In another aspect, a method is provided for synthesizing a polymer. In some aspects, the method comprises reacting a polyol and an optionally substituted lactone to form a polylactone. In some aspects, the method further comprises crosslinking the polylactone to form the polymer. In some aspects, the reacting of a polyol and an optionally substituted lactone occurs in the presence of a catalyst. In some aspects, the method further comprises treating the polymer with a hydrolysis stabilizer. In some aspects, the polylactone is at least partially crosslinked with a divinyl ether. In another aspect, a polymer is provided prepared by the methods described herein.

The details of one or more aspects of the disclosure are set forth in the accompanying drawings and the description below. Other features, objects, and advantages of the disclosure will be apparent from the description, the drawings, and the claims.

### DESCRIPTION OF DRAWINGS

FIGS. 1A-1C provide a schematic illustration of Pδ vitrimer synthesis as described in the examples. (FIG. 1A) The chemistry for Pδ and Pδ vitrimer synthesis, and the cured v-δ1 with excessed vinyl ether (light yellow) or hydroxyl (transparent). (FIG. 1B) Schematic illustration of Pδ vitrimer from monomers to crosslinked network. (FIG. 1C) Hydrolytic degradation of v-δ1 without and with post-treatment; the post-treated sample was stable after 30 days in air.

FIGS. 2A-2J provide the properties and potential applications of Pδ vitrimers as described in the examples. Thermomechanical properties measured from (FIG. 1A) DMA, (FIG. 1B) DSC, (FIG. 1C) uniaxial tensile, and (FIG. 1D) cyclic tensile tests of v-δ1 with a strain of 50%. Using Pδ vitrimers as actuators (FIG. 1E) A mold-cured pneumatic actuator and (FIG. 1F) a magnetic actuator fabricated with v-δ1; the magnetic actuator has 4 segments with different magnetic poles (N-S), and B is the applied magnetic field. Optical properties: (FIG. 1G) UV-vis transmittance and (FIG. 1H) a photo image of v-δ1. Potential use as molding materials: (FIG. 1I) Water contact angle of Pδ vitrimers comparing with poly(dimethyl)siloxane (PDMS) (inserted) and (FIG. 2J) gelatin jelly and silicone rubber cured lucky cats with a v-δ7 fabricated mold. All scale bars are 1 cm.

FIGS. 3A-3H depict the dynamic network performance of Pδ vitrimers as described in the examples. (FIG. 3A) Schematic of the chemistry of acetal metathesis exchange reaction and acetal vitrimer network breaking and reforming. (FIG. 3B) Stress relaxation of v-δ1 at different temperature. (FIG. 3C) The Arrhenius plot of the characteristic relaxation time τ* versus inverse temperature for Pδ vitrimers. (FIG. 3D) Tensile comparison of reprocessed v-δ1. (FIG. 3E) Reshape of v-δ1 film into a convex lens. (FIG. 3F) Hot-stamping imprint of microchannel on v-δ1. (FIG. 3G) Self-healing of v-δ1 actuator. (FIG. 3H) Reprocessing of v-δ1 by hot-press molding. All scale bar is 1 cm.

FIGS. 4A-4E depict the degradation and upcycling of Pδ vitrimer as described in the examples. (FIG. 4A) Schematic of Pδ vitrimer depolymerization. (FIG. 4B) TGA curves of Pδ vitrimers. (FIG. 4C) Photo of v-δ1 degraded from solid to liquid oligomer with a thermal gun. (FIG. 4D) Overlay of ¹H NMR spectra of (i) pristine 6-1 monomer, (ii) recycled δ-1 monomer and (iii) undepolymerized oligomers from c). (FIG. 4E) Depolymerization of v-δ1(i) into δ-1(ii) and re-synthesis into v-δ1 magnetic composite (iii) and depolymerization again and separation the magnetic particles (iv).

FIG. 5 provides the GC-MS of small-molecule model experiment reaction 1 as described in the examples.

FIG. 6 provides the GC-MS of small-molecule model experiment reaction 2 as described in the examples.

FIG. 7 provides the GC-MS of small-molecule model experiment reaction 3 as described in the examples.

FIG. 8 provides the FTIR spectra of P-δ1 and crosslinked v-δ1 with different vinyl ether to hydroxyl ratios.

FIG. 9 provides the FTIR of as synthesized v-δ1 (with TEA treatment) and hydrolyzed v-δ1. Highlighted range refers to the hydroxyl peak.

FIGS. 10A-10B provide (FIG. 10A) DSC and (FIG. 10B) TGA curves of P-δ1 triol.

FIGS. 11A-11B provide (FIG. 11A) DSC and (FIG. 11B) TGA curves of P-δ4 triol.

FIGS. 12A-12B provide (FIG. 12A) DSC and (FIG. 12B) TGA curves of P-δ7 triol.

FIG. 13 provides stress-strain curves of v-δ1 synthesized with different molecular weights.

FIG. 14 provides the Young's modulus of v-δ1 with cyclic reprocessing.

FIG. 15 provides a thermal degradation comparison with different stoichiometric ratios of v-δ1, r represents the vinyl group: hydroxyl group in molar ratio.

FIG. 16 provides vapor IR spectra of v-δ1 from in-situ TGA-IR.

FIG. 17 provides SEC curves of synthesized P-δ1 triol with virgin δ1 and recycled δ1 in DMF.

FIG. 18 provides strain stress curves of synthesized v-δ1 with virgin δ1 and recycled δ1.

FIG. 19 provides the ¹H NMR spectrum of virgin δ1 in CDCl₃. Arrows refer to characteristic peaks of the ring monomer.

FIG. 20 provides the ¹H NMR spectrum of recycled δ1 from v-δ1 in CDCl₃. Arrows refer to characteristic peaks of the ring monomer.

FIG. 21 provides the ¹H NMR spectrum of P-δ1 triol in CDCl₃. Arrows refer to characteristic peaks of the polymer.

FIG. 22 provides the ¹H NMR spectrum of virgin δ4 in CDCl₃. Arrows refer to characteristic peaks of the ring monomer.

FIG. 23 provides the ¹H NMR spectrum of recycled δ4 from v-δ4 in CDCl₃. Arrows refer to characteristic peaks of the ring monomer.

FIG. 24 provides the ¹H NMR spectrum of P-δ4 triol in CDCl₃. Arrows refer to characteristic peaks of the polymer.

FIG. 25 provides the ¹H NMR spectrum of virgin δ7 in CDCl₃. Arrows refer to characteristic peaks of the ring monomer.

FIG. 26 provides the ¹H NMR spectrum of recycled δ7 from v-δ7 in CDCl₃. Arrows refer to characteristic peaks of the ring monomer.

FIG. 27 provides the ¹H NMR spectrum of P-δ7 triol in CDCl₃. Arrows refer to characteristic peaks of the polymer.

FIG. 28 provides SEC curves of P-δ1, P-δ4, and P-δ7 triol in DMF.

Like reference symbols in the various drawings indicate like elements.

### DETAILED DESCRIPTION

The following description of the disclosure is provided as an enabling teaching of the disclosure in its best, currently known aspects. Many modifications and other aspects disclosed herein will come to mind to one skilled in the art to which the disclosed compositions and methods pertain, benefiting from the teachings presented in the descriptions herein and the associated drawings. Therefore, it is understood that the disclosures are not limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As apparent to those of skill in the art upon reading this disclosure, each of the individual aspects described and illustrated herein has discrete components and features that may be readily separated from or combined with the features of any of the other several aspects without departing from the scope or spirit of the present disclosure.

Any recited method can be carried out in the order of events recited or any other order that is logically possible. Unless otherwise expressly stated, it is in no way intended that any method or aspect set forth herein be construed as requiring that its steps be performed in a specific order. Accordingly, where a method claim does not explicitly state in the claims or descriptions that the steps are to be limited to a particular order, it is in no way intended that an order be inferred in any respect. This holds for any possible non-express basis for interpretation, including logic concerning arrangement of steps or operational flow, meaning derived from grammatical organization or punctuation, or the number or type of aspects described in the specification.

All publications mentioned herein are incorporated by reference to disclose and describe the methods or materials in connection with which the publications are cited. The publications discussed herein are provided solely for their disclosure before the filing date of the present application. Further, the dates of publication provided herein can be different from the actual publication dates, which can require independent confirmation.

It is also to be understood that the terminology herein describes particular aspects only and is not intended to be limiting. Unless defined otherwise, all technical and scientific terms herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Before describing the various aspects of the present disclosure, the following definitions are provided and should be used unless otherwise indicated. Additional terms may be defined elsewhere in the present disclosure.

### Definitions

As used herein, “comprising” is interpreted as specifying the presence of the stated features, integers, steps, or components but does not preclude the presence or addition of one or more features, integers, steps, components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, “consisting essentially of” is intended to include examples encompassed by the term “consisting of.”

As used in the specification and the appended claims, the singular forms “a,” “an,” and “the” include plural referents unless the context dictates otherwise.

Ratios, concentrations, amounts, and other numerical data can be expressed herein in a range format. Further, the endpoints of each of the ranges are significant both in relation to the other endpoint and independently of the other endpoint. There are many values disclosed herein, and each value is also disclosed as “about” that particular value in addition to the value itself. For example, if the value “10” is disclosed, then “about 10” is also disclosed. Ranges can be expressed herein as from “about” one particular value and to “about” another particular value. Similarly, when values are expressed as approximations, using the antecedent “about,” the particular value forms a further aspect. For example, if the value “about 10” is disclosed, then “10” is also disclosed.

When a range is expressed, a further aspect includes from the one particular value and to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x,’ ‘about y,’ and ‘about z’ as well as the ranges of ‘less than x,’ ‘less than y.’ and ‘less than z.’ Likewise, the phrase ‘about x, y, z, or greater’ should be interpreted to include the specific ranges of ‘about x,’ ‘about y,’ and ‘about z’ as well as the ranges of ‘greater than x,’ greater than y,’ and ‘greater than z.’ In addition, the phrase “about ‘x’ to ‘y’,” where ‘x’ and ‘y’ are numerical values, includes “about ‘x’ to about ‘y’.”

Such a range format is used for convenience and brevity and, thus, should be interpreted flexibly to include not only the numerical values explicitly recited as the limits of the range but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5% but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, amounts, sizes, formulations, parameters, and other quantities and characteristics are not and need not be exact but may be approximate, larger or smaller, as desired, reflecting tolerances, conversion factors, rounding, measurement error, and the like, and other factors known to those of skill in the art such that equivalent results or effects are obtained. In some circumstances, the value that provides equivalent results or effects cannot be reasonably determined. In such cases, as used herein, “about” and “at or about” mean the nominal value indicated ±10% variation unless otherwise indicated or inferred. In general, an amount, size, formulation, parameter, or other quantity or characteristic is “about,” “approximate,” or “at or about,” whether or not expressly stated to be such. Where “about,” “approximate,” or “at or about” is used before a quantitative value, the parameter also includes the specific quantitative value itself unless expressly stated otherwise.

As used herein, “optional” or “optionally” means that the subsequently described event or circumstance can or cannot occur. The description includes instances where said event or circumstance occurs and those where it does not.

The terms “coupled” and “associated” generally mean electrically, electromagnetically, and/or physically (e.g., mechanically or chemically) coupled or linked and do not exclude the presence of intermediate elements between the coupled or associated items.

It will be understood that when an element is referred to as being “connected” or “coupled” to another element, it can be directly connected or coupled to the other element, or intervening elements can be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “substantially” means that the subsequently described event or circumstance completely occurs or that the subsequently described event or circumstance generally, typically, or approximately occurs.

Still further, the term “substantially” can, in some aspects, refer to at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

### Chemical Definitions

Compounds are described using standard nomenclature. Unless defined otherwise, all technical and scientific terms used herein have the same meaning as is commonly understood by one of skill in the art to which this disclosure belongs.

The compounds described herein include enantiomers, mixtures of enantiomers, diastereomers, tautomers, racemates, and other isomers, such as rotamers, as if each is specifically described unless otherwise indicated or otherwise excluded by context. It is to be understood that the compounds provided herein may contain chiral centers. Such chiral centers may be of either the (R-) or (S-) configuration. The compounds provided herein may either be enantiomerically pure or diastereomeric or enantiomeric mixtures. Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture.

Compounds described herein may contain one or more double bonds and, thus, potentially give rise to cis/trans (E/Z) isomers, as well as other conformational isomers. Unless stated to the contrary, all such possible isomers are contemplated, as well as mixtures of such isomers.

Compounds described herein may also present as an equilibrium of tautomers. For example, ketones with an a-hydrogen can exist in an equilibrium of the keto form and the enol form. Likewise, amides with an N-hydrogen can exist in an equilibrium of the amide form and the imidic acid form. Unless stated to the contrary, all possible tautomers of the compounds described herein are contemplated.

A dash (“-”) that is not between two letters or symbols is used to indicate a point of attachment for a substituent. For example, —(C═O)NH₂ is attached through the carbon of the keto (C═O) group.

The term “substituted,” as used herein, means that any one or more hydrogens on the designated atom or group are replaced with a moiety selected from the indicated group, provided that the designated atom's normal valence is not exceeded and the resulting compound is stable. For example, when the substituent is oxo (i.e., ═O), two hydrogens on the atom are replaced. For example, a pyridyl group substituted by oxo is a pyridine. Combinations of substituents and/or variables are permissible only if such combinations result in stable compounds or useful synthetic intermediates. A stable active compound refers to a compound that can be isolated and/or can be formulated into a form with a shelf life of at least one month. A stable manufacturing intermediate or precursor to an active compound is stable if it does not degrade within the period needed for reaction or other use. A stable moiety or substituent group is one that does not degrade, react, or fall apart within the period necessary for use. Non-limiting examples of unstable moieties are those that combine heteroatoms in an unstable arrangement, as typically known and identifiable to those of skill in the art.

Any suitable group may be present on a “substituted” or “optionally substituted” position that forms a stable molecule and meets the desired purpose of the disclosure and includes, but is not limited to: alkyl, haloalkyl, alkoxy, alkenyl, alkynyl, aryl, heteroaryl, cycloalkyl, heterocycle, aldehyde, amino, carboxylic acid, ester, ether, halo, hydroxy, keto, nitro, cyano, azido, oxo, silyl, sulfo-oxo, sulfonyl, sulfone, sulfoxide, sulfonylamino, or thiol.

The terms for various functional groups as used herein are not intended to be limited to monovalent radicals and may include polyvalent radical groups as appropriate, such as divalent, trivalent, tetravalent, pentavalent, and hexavalent groups, and the like, based on the position and location of such groups in the compounds described herein as would be readily understood by the skilled person in the context in which said functional groups are recited.

As used herein, the symbol

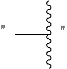

(which hereinafter can be referred to as “a point of attachment bond”) denotes a bond that is a point of attachment between two chemical entities, one of which is depicted as being attached to the point of attachment bond and the other of which is not depicted as being attached to the point of attachment bond. For example,

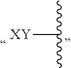

indicates that the chemical entity “XY” is bonded to another chemical entity via the point of attachment bond. Furthermore, the specific point of attachment to the non-depicted chemical entity can be specified by inference. For example, the compound CH₃—R³, wherein R³ is H or

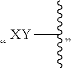

infers that when R³ is “XY,” the point of attachment bond is the same bond as the bond by which R³ is depicted as being bonded to CH₃.

“Alkyl” is a straight chain or branched saturated aliphatic hydrocarbon group. In certain aspects, the alkyl is C₁-C₂, C₁-C₃, or C₁-C₆ (i.e., the alkyl chain can be 1, 2, 3, 4, 5, or 6 carbons in length). The specified ranges, as used herein, indicate an alkyl group with the length of each member of the range described as an independent species. For example, C₁-C₆alkyl, as used herein, indicates an alkyl group having from 1, 2, 3, 4, 5, or 6 carbon atoms and is intended to mean that each of these is described as an independent species, and C₁-C₄alkyl, as used herein indicates an alkyl group having from 1, 2, 3, or 4 carbon atoms and is intended to mean that each of these is described as an independent species. When C₀-Cₙalkyl is used herein in conjunction with another group, for example (C₃-C₇cycloalkyl)C₀-C₄alkyl, or —C₀-C₄(C₃-C₇cycloalkyl), the indicated group, in this case cycloalkyl, is either directly bound by a single covalent bond (C₀alkyl), or attached by an alkyl chain, in this case 1, 2, 3, or 4 carbon atoms. Alkyls can also be attached via other groups, such as heteroatoms, such as O—C₀-C₄alkyl(C₃-C₇cycloalkyl). Examples of alkyl include but are not limited to, methyl, ethyl, n-propyl, isopropyl, n-butyl, isobutyl, sec-butyl, t-butyl, n-pentyl, isopentyl, tert-pentyl, neopentyl, n-hexyl, 2-methylpentane, 3-methylpentane, 2,2-dimethylbutane, and 2,3-dimethylbutane. In some aspects, the alkyl group is optionally substituted as described herein.

“Cycloalkyl” is a saturated or partially unsaturated mono- or multi-cyclic hydrocarbon ring system. When composed of two or more rings, the rings may be joined together in a fused or bridged fashion. Non-limiting examples of typical cycloalkyl groups include cyclopropyl, cyclobutyl, cyclopentyl, cyclohexyl, and cycloheptyl. In some aspects, the cycloalkyl group is optionally substituted as described herein.

“Alkenyl” is a straight or branched chain aliphatic hydrocarbon group having one or more carbon-carbon double bonds, each of which is independently either cis or trans, that may occur at a stable point along the chain. Non-limiting examples include C₂-C₄alkenyl and C₂-C₆alkenyl (i.e., having 2, 3, 4, 5, or 6 carbons). The specified ranges as used herein indicate an alkenyl group, with each member of the range described as an independent species, as described above for the alkyl moiety. Examples of alkenyl include but are not limited to, ethenyl and propenyl. In one aspect, the alkenyl group is optionally substituted as described herein.

“Alkynyl” is a straight or branched chain aliphatic hydrocarbon group having one or more carbon-carbon triple bonds that may occur at any stable point along the chain, for example, C₂-C₄alkynyl or C₂-C₆alkynyl (i.e., having 2, 3, 4, 5, or 6 carbons). The specified ranges as used herein indicate an alkynyl group, with each member of the range described as an independent species, as described above for the alkyl moiety. Examples of alkynyl include, but are not limited to, ethynyl, propynyl, 1-butynyl, 2-butynyl, 3-butynyl, 1-pentynyl, 2-pentynyl, 3-pentynyl, 4-pentynyl, 1-hexynyl, 2-hexynyl, 3-hexynyl, 4-hexynyl, and 5-hexynyl. In one aspect, the alkynyl group is optionally substituted as described herein.

“Alkoxy” is an alkyl group, as defined above, covalently bound through an oxygen bridge (—O—). Examples of alkoxy include but are not limited to, methoxy, ethoxy, n-propoxy, isopropoxy, n-butoxy, 2-butoxy, tert-butoxy, n-pentoxy, 2-pentoxy, 3-pentoxy, isopentoxy, neopentoxy, n-hexoxy, 2-hexoxy, 3-hexoxy, and 3-methylpentoxy. Similarly, an “alkylthio” or “thioalkyl” group is an alkyl group, as defined above, with the indicated number of carbon atoms covalently bound through a sulfur bridge (—S—).

“Alkanoyl” is an alkyl group, as defined above, covalently bound through a carbonyl (C═O) bridge. The carbonyl carbon is included in the number of carbons. For example C₂alkanoyl is a CH₃(C═O)— group. In one aspect, the alkanoyl group is optionally substituted as described herein.

“Halo” or “halogen” indicates independently any of fluoro, chloro, bromo or iodo.

“Aryl” indicates an aromatic group containing only carbon in the aromatic ring or rings. In one aspect, the aryl group contains 1 to 3 separate or fused rings and is 6 to 14 or 18 ring atoms, without heteroatoms as ring members. When indicated, such aryl groups may be further substituted with carbon or non-carbon atoms or groups. Such substitution may include fusion to a 4- to 7- or 5- to 7-membered saturated or partially unsaturated cyclic group that optionally contains 1, 2, or 3 heteroatoms independently selected from N, O, B, P, Si, and S to form, for example, a 3,4-methylenedioxyphenyl group. Aryl groups include, for example, phenyl and naphthyl, including 1-naphthyl and 2-naphthyl. In one aspect, aryl groups are pendant. An example of a pendant ring is a phenyl group substituted with a phenyl group. In one aspect, the aryl group is optionally substituted as described herein.

The term “heterocycle” refers to saturated and partially saturated heteroatom-containing ring radicals, where the heteroatoms may be selected from N, O, and S. The term heterocycle includes monocyclic 3-12 members rings, as well as bicyclic 5-16 membered ring systems (which can include fused, bridged, or spiro bicyclic ring systems). It does not include rings containing —O—O—, —O—S—, and —S—S— portions. Examples of saturated heterocycle groups including saturated 4- to 7-membered monocyclic groups containing 1 to 4 nitrogen atoms [e.g., pyrrolidinyl, imidazolidinyl, piperidinyl, pyrrolinyl, azetidinyl, piperazinyl, and pyrazolidinyl]; saturated 4- to 6-membered monocyclic groups containing 1 to 2 oxygen atoms and 1 to 3 nitrogen atoms [e.g., morpholinyl]; and saturated 3- to 6-membered heteromonocyclic groups containing 1 to 2 sulfur atoms and 1 to 3 nitrogen atoms [e.g., thiazolidinyl]. Examples of partially saturated heterocycle radicals include, but are not limited to, dihydrothienyl, dihydropyranyl, dihydrofuryl, and dihydrothiazolyl. Examples of partially saturated and saturated heterocycle groups include, but are not limited to, pyrrolidinyl, imidazolidinyl, piperidinyl, pyrrolinyl, pyrazolidinyl, piperazinyl, morpholinyl, tetrahydropyranyl, thiazolidinyl, dihydrothienyl, 2,3-dihydro-benzo[1,4]dioxanyl, indolinyl, isoindolinyl, dihydrobenzothienyl, dihydrobenzofuryl, isochromanyl, chromanyl, 1,2-dihydroquinolyl, 1,2,3,4-tetrahydro-isoquinolyl, 1,2,3,4-tetrahydro-quinolyl, 2,3,4,4a,9,9a-hexahydro-1H-3-aza-fluorenyl, 5,6,7-trihydro-1,2,4-triazolo[3,4-a]isoquinolyl, 3,4-dihydro-2H-benzo[1,4]oxazinyl, benzo[1,4]dioxanyl, 2,3,-dihydro-1H-benzo[d]isothiazol-6-yl, dihydropyranyl, dihydrofuryl, and dihydrothiazolyl. Bicyclic heterocycle includes groups wherein the heterocyclic radical is fused with an aryl radical, and the point of attachment is the heterocycle ring. Bicyclic heterocycle also includes heterocyclic radicals that are fused with a carbocyclic radical. Representative examples include but are not limited to, partially unsaturated condensed heterocyclic groups containing 1 to 5 nitrogen atoms, for example, indoline and isoindoline, partially unsaturated condensed heterocyclic groups containing 1 to 2 oxygen atoms and 1 to 3 nitrogen atoms, partially unsaturated condensed heterocyclic groups containing 1 to 2 sulfur atoms and 1 to 3 nitrogen atoms, and saturated condensed heterocyclic groups containing 1 to 2 oxygen or sulfur atoms.

“Heteroaryl” refers to a stable monocyclic, bicyclic, or multicyclic aromatic ring that contains from 1 to 4, or in some aspects, 1, 2, or 3 heteroatoms selected from N, O, S, B, and P (and typically selected from N, O, and S) with remaining ring atoms being carbon, or a stable bicyclic or tricyclic system containing at least one 5, 6, or 7 membered aromatic ring which contains from 1 to 4, or in some aspects from 1 to 3 or from 1 to 2, heteroatoms selected from N, O, S, B, or P, with remaining ring atoms being carbon. In one aspect, the only heteroatom is nitrogen. In one aspect, the only heteroatom is oxygen. In one aspect, the only heteroatom is sulfur. Monocyclic heteroaryl groups typically have from 5 to 6 ring atoms. In some aspects, bicyclic heteroaryl groups are 8- to 10-membered heteroaryl groups, that is groups containing 8 or 10 ring atoms in which one 5-, 6-, or 7-membered aromatic ring which contains from 1 to 4 heteroatoms selected from N, O, S, B, or P is fused to a second aromatic or non-aromatic ring, wherein the point of attachment is an aromatic ring. When the total number of S and O atoms in the heteroaryl ring exceeds 1, these heteroatoms are not adjacent to one another within the ring. In one aspect, the total number of S and O atoms in the heteroaryl ring is not more than 2. In another aspect, the total number of S and O atoms in the heteroaryl ring is not more than 1. Examples of heteroaryl groups include, but are not limited to, pyridinyl, imidazolyl, imidazopyridinyl, pyrimidinyl, pyrazolyl, triazolyl, pyrazinyl, furyl, thienyl, isoxazolyl, thiazolyl, oxadiazolyl, oxazolyl, isothiazolyl, pyrrolyl, quinolinyl, isoquinolinyl, tetrahydroisoquinolinyl, indolyl, benzimidazolyl, benzofuranyl, cinnolinyl, indazolyl, indolizinyl, phthalazinyl, pyridazinyl, triazinyl, isoindolyl, pteridinyl, purinyl, triazolyl, thiadiazolyl, furazanyl, benzofurazanyl, benzothiophenyl, benzothiazolyl, benzoxazolyl, quinazolinyl, quinoxalinyl, naphthyridinyl, and furopyridinyl.

As used herein, the term “derivative” refers to a compound having a structure derived from the structure of a parent compound (e.g., a compound disclosed herein) and whose structure is sufficiently similar to those disclosed herein and based upon that similarity would be expected by one skilled in the art to exhibit the same or similar activities and utilities as the claimed compounds, or to induce, as a precursor, the same or similar activities and utilities as the claimed compound. Exemplary derivatives include but are not limited to, salts, esters, amides, salts of esters or amides, and N-oxides of a parent compound.

As used herein, substantially pure means sufficiently homogeneous to appear free of readily detectable impurities as determined by standard methods of analysis, such as thin layer chromatography (TLC), nuclear magnetic resonance (NMR), gel electrophoresis, high-performance liquid chromatography (HPLC) and mass spectrometry (MS), gas-chromatography mass spectrometry (GC-MS), and similar, used by those of skill in the art to assess such purity, or sufficiently pure such that further purification would not detectably alter the physical and chemical properties, such as enzymatic and biological activities, of the substance. Both traditional and modern methods for purification of the compounds to produce substantially chemically pure compounds are known to those of skill in the art. A substantially chemically pure compound may, however, be a mixture of stereoisomers.

Certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Sigma-Aldrich (formally MilliporeSigma, Burlington, MA) or Thermo Fisher Scientific Inc. (Waltham, MA) or are prepared by methods known to those skilled in the art following procedures set forth in references such as Fieser and Fieser's Reagents for Organic Synthesis (John Wiley and Sons, 2007); Organic Reactions (John Wiley and Sons, 2004); March's Advanced Organic Chemistry, (John Wiley and Sons, 8^{th} Edition); and Larock's Comprehensive Organic Transformations (John Wiley and Sons, 3^{rd} edition, 2017).

### Polymers

The present disclosure provides polymer compositions that are crosslinked thermosets. The disclosed polymers provide material characteristics comparable to polydimethylsiloxane (PDMS) while also providing the advantageous properties of vitrimers, such as welding, healing, reprocessing, and reshaping.

Thus, in one aspect, the present disclosure provides polymers and articles comprising said polymers. In some aspects, the polymer comprises one or more constitutional units derived from a polyol. In some further aspects, the polymer comprises one or more constitutional units derived from an optionally substituted lactone. In even further aspects, the polymer is at least partially crosslinked.

In some aspects, the polymer is a vitrimer. As used herein, a “vitrimer” is a polymer comprising a molecular covalent network that can change topology by thermally activated bond-exchange reactions.

In some aspects, the polymer comprises one or more constitutional units derived from a polyol having a structure of Formula (I):

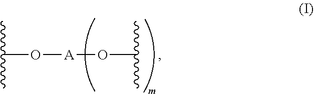

wherein:

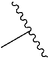

is a point of attachment of the structure of Formula (I) within the polymer;
m is an integer selected from 1 to 5;
A is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

In some aspects, m is 1. In some aspects, m is 2. In some aspects, m is 3, In some aspects, m is 4. In some aspects, m is 5.

In some aspects, A is C₁-C₁₂ alkyl optionally substituted with one or more groups selected from Z as allowed by valency. In some aspects, A is selected from methyl, ethyl, n-propyl, isopropyl, n-butyl, isobutyl, sec-butyl, t-butyl, n-pentyl, isopentyl, tert-pentyl, neopentyl, n-hexyl, 2-methylpentane, 3-methylpentane, 2,2-dimethylbutane, and 2,3-dimethylbutane.

In some aspects, A is C₂-C₁₂ alkenyl optionally substituted with one or more groups selected from Z as allowed by valency. In some aspects, A is selected from ethenyl and propenyl.

In some aspects, A is C₂-C₁₂ alkynyl optionally substituted with one or more groups selected from Z as allowed by valency. In some aspects, A is selected from ethynyl, propynyl, and propargyl.

In some aspects, A is C₃-C₆ cycloalkyl optionally substituted with one or more groups selected from Z as allowed by valency. In some aspects, A is selected from cyclopropyl, cyclobutyl, cyclopentyl, cyclohexyl, and cycloheptyl.

In some aspects, A is a 3- to 8-membered monocyclic or bicyclic heterocycle optionally substituted with one or more groups selected from Z as allowed by valency. In some aspects, A is selected from pyrrolidinyl, imidazolidinyl, piperidinyl, pyrrolinyl, azetidinyl, piperazinyl, pyrazolidinyl, morpholinyl, tetrahydrofuranyl, tetrahydropyranyl, thiazolidinyl, indolinyl, and isoindolinyl.

In some aspects, A is a 6- to 10-membered monocyclic or bicyclic aryl optionally substituted with one or more groups selected from Z as allowed by valency. In some aspects, A is selected from phenyl and naphthyl.

In some aspects, A is a 5- to 10-membered monocyclic or bicyclic heteroaryl optionally substituted with one or more groups selected from Z as allowed by valency. In some aspects, A is selected from pyridinyl, imidazolyl, imidazopyridinyl, pyrimidinyl, pyrazolyl, triazolyl, pyrazinyl, furyl, thienyl, isoxazolyl, thiazolyl, oxadiazolyl, oxazolyl, pyrrolyl, quinolinyl, isoquinolinyl, indolyl, benzimidazolyl, benzofuranyl, indazolyl, indolizinyl, phthalazinyl, pyridazinyl, triazinyl, isoindolyl, pteridinyl, purinyl, thiadiazolyl, furazanyl, benzofurazanyl, benzothiophenyl, benzothiazolyl, benzoxazolyl, quinazolinyl, quinoxalinyl, naphthyridinyl, and furopyridinyl.

In some aspects, A is a polyether optionally substituted with one or more groups selected from Z as allowed by valency. In some aspects, A is polyethylene glycol or polypropylene glycol.

In some aspects, A comprises a combination of any of the above recited A groups.

In some aspects, the one or more constitutional units derived from a polyol comprises

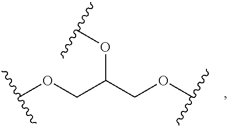 [SMILES: *OCC(CO*)O* ; ","]

wherein

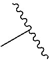

is a point of attachment within the polymer.

In some aspects, the polymer comprises one or more constitutional units derived from an optionally substituted lactone having a structure of Formula (II):

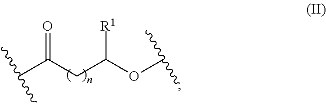

wherein:

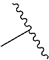

is a point of attachment of the structure of Formula (II) within the polymer;
n is an integer selected from 1 to 4;
R¹ is selected from hydrogen, C₁-C₁₂ alkyl, C₁-C₁₂ haloalkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, and 5- to 10-membered monocyclic or bicyclic heteroaryl, or a combination thereof, each of which may be optionally substituted with one or more groups selected from Z as allowed by valency;
and all other variables are as defined herein.

In some aspects, n is 1. In some aspects, n is 2. In some aspects, n is 3. In some aspects, n is 4.

In some aspects, R¹ is C₁-C₁₂ alkyl optionally substituted with one or more groups selected from Z as allowed by valency. In some aspects, R¹ is selected from methyl, ethyl, n-propyl, isopropyl, n-butyl, isobutyl, sec-butyl, t-butyl, n-pentyl, isopentyl, tert-pentyl, neopentyl, n-hexyl, 2-methylpentane, 3-methylpentane, 2,2-dimethylbutane, and 2,3-dimethylbutane.

In some aspects, R¹ is C₁-C₁₂ haloalkyl optionally substituted with one or more groups selected from Z as allowed by valency. In some aspects, R¹ is selected from trifluoromethyl, trifluoroethyl, and hexafluoroisopropyl.

In some aspects, R¹ is C₂-C₁₂ alkenyl optionally substituted with one or more groups selected from Z as allowed by valency. In some aspects, R¹ is selected from ethenyl and propenyl.

In some aspects, R¹ is C₂-C₁₂ alkynyl optionally substituted with one or more groups selected from Z as allowed by valency. In some aspects, R¹ is selected from ethynyl, propynyl, and propargyl.

In some aspects, R¹ is C₃-C₆ cycloalkyl optionally substituted with one or more groups selected from Z as allowed by valency. In some aspects, R¹ is selected from cyclopropyl, cyclobutyl, cyclopentyl, cyclohexyl, and cycloheptyl.

In some aspects, R¹ is a 3- to 8-membered monocyclic or bicyclic heterocycle optionally substituted with one or more groups selected from Z as allowed by valency. In some aspects, R¹ is selected from pyrrolidinyl, imidazolidinyl, piperidinyl, pyrrolinyl, azetidinyl, piperazinyl, pyrazolidinyl, morpholinyl, tetrahydrofuranyl, tetrahydropyranyl, thiazolidinyl, indolinyl, and isoindolinyl.

In some aspects, R¹ is a 6- to 10-membered monocyclic or bicyclic aryl optionally substituted with one or more groups selected from Z as allowed by valency. In some aspects, R¹ is selected from phenyl and naphthyl.

In some aspects, R¹ is a 5- to 10-membered monocyclic or bicyclic heteroaryl optionally substituted with one or more groups selected from Z as allowed by valency. In some aspects, R¹ is selected from pyridinyl, imidazolyl, imidazopyridinyl, pyrimidinyl, pyrazolyl, triazolyl, pyrazinyl, furyl, thienyl, isoxazolyl, thiazolyl, oxadiazolyl, oxazolyl, pyrrolyl, quinolinyl, isoquinolinyl, indolyl, benzimidazolyl, benzofuranyl, indazolyl, indolizinyl, phthalazinyl, pyridazinyl, triazinyl, isoindolyl, pteridinyl, purinyl, thiadiazolyl, furazanyl, benzofurazanyl, benzothiophenyl, benzothiazolyl, benzoxazolyl, quinazolinyl, quinoxalinyl, naphthyridinyl, and furopyridinyl.

In some aspects, R¹ comprises a combination of any of the above recited R¹ groups.

In some aspects, the one or more constitutional units derived from a polyol and the one or more constitutional units derived from an optionally substituted lactone are directly connected.

In some aspects, the polymer comprises one or more constitutional units having the structure:

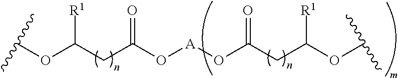

wherein all variables are as defined herein.

In some aspects, the polymer is at least partially crosslinked. In some aspects, the polymer is substantially crosslinked. In some aspects, the polymer is at least partially crosslinked with a divinyl ether. Thus, in some aspects, the polymer further comprises one or more crosslinking units derived from the divinyl ether.

In some aspects, the one or more crosslinking units comprise a structure of Formula (III):

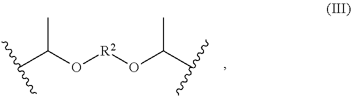

wherein:

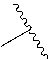

is a point of attachment of the structure of Formula (III) within the polymer;
R² is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
and all other variables are as defined herein.

In some aspects, R² is C₁-C₁₂ alkyl optionally substituted with one or more groups selected from Z as allowed by valency. In some aspects, R² is selected from methyl, ethyl, n-propyl, isopropyl, n-butyl, isobutyl, sec-butyl, t-butyl, n-pentyl, isopentyl, tert-pentyl, neopentyl, n-hexyl, 2-methylpentane, 3-methylpentane, 2,2-dimethylbutane, and 2,3-dimethylbutane.

In some aspects, R² is C₂-C₁₂ alkenyl optionally substituted with one or more groups selected from Z as allowed by valency. In some aspects, R² is selected from ethenyl and propenyl.

In some aspects, R² is C₂-C₁₂ alkynyl optionally substituted with one or more groups selected from Z as allowed by valency. In some aspects, R² is selected from ethynyl, propynyl, and propargyl.

In some aspects, R² is C₃-C₆ cycloalkyl optionally substituted with one or more groups selected from Z as allowed by valency. In some aspects, A is selected from cyclopropyl, cyclobutyl, cyclopentyl, cyclohexyl, and cycloheptyl.

In some aspects, R² is a 3- to 8-membered monocyclic or bicyclic heterocycle optionally substituted with one or more groups selected from Z as allowed by valency. In some aspects, R² is selected from pyrrolidinyl, imidazolidinyl, piperidinyl, pyrrolinyl, azetidinyl, piperazinyl, pyrazolidinyl, morpholinyl, tetrahydrofuranyl, tetrahydropyranyl, thiazolidinyl, indolinyl, and isoindolinyl.

In some aspects, R² is a 6- to 10-membered monocyclic or bicyclic aryl optionally substituted with one or more groups selected from Z as allowed by valency. In some aspects, R² is selected from phenyl and naphthyl.

In some aspects, R² is a 5- to 10-membered monocyclic or bicyclic heteroaryl optionally substituted with one or more groups selected from Z as allowed by valency. In some aspects, R² is selected from pyridinyl, imidazolyl, imidazopyridinyl, pyrimidinyl, pyrazolyl, triazolyl, pyrazinyl, furyl, thienyl, isoxazolyl, thiazolyl, oxadiazolyl, oxazolyl, pyrrolyl, quinolinyl, isoquinolinyl, indolyl, benzimidazolyl, benzofuranyl, indazolyl, indolizinyl, phthalazinyl, pyridazinyl, triazinyl, isoindolyl, pteridinyl, purinyl, thiadiazolyl, furazanyl, benzofurazanyl, benzothiophenyl, benzothiazolyl, benzoxazolyl, quinazolinyl, quinoxalinyl, naphthyridinyl, and furopyridinyl.

In some aspects, R² is a polyether optionally substituted with one or more groups selected from Z as allowed by valency. In some aspects, R² is polyethylene glycol or polypropylene glycol.

In some aspects, R² comprises a combination of any of the above recited R² groups.

In some aspects, R² is

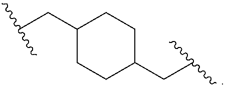 [SMILES: *CC1CCC(C*)CC1]

In another aspect, a polymer is provided formed from one or more monomers comprising a polyol and one or more monomers comprising an optionally substituted lactone. In some aspects, the polymer is at least partially crosslinked. In some aspects, the polymer is a vitrimer.

In some aspects, the one or more monomers comprising a polyol comprise a compound of Formula (I-a):

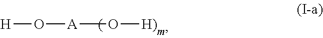

wherein all variables are as defined herein.

Representative examples of suitable polyols include but are not limited to, glycerol, trimethylolpropane, pentaerythritol, ethylene glycol, 1,5-butanediol, 1,2,5-hexanetriol, diethylene glycol, triethylene glycol, maltitol, sorbitol, xylitol, erythritol, isomalt, malic acid, a polyalkylene glycol (such as polyethylene glycol or polypropylene glycol), a polyvinyl alcohol, a polyether polyol, a polyester polyol, or combinations thereof.

In some aspects, the polyol is glycerol.

In some aspects, one or more monomers comprising an optionally substituted lactone comprise a compound of Formula (II-a):

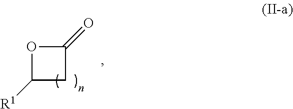

wherein all variables are as defined herein.

In some aspects, one or more monomers comprising an optionally substituted lactone comprise a compound selected from:

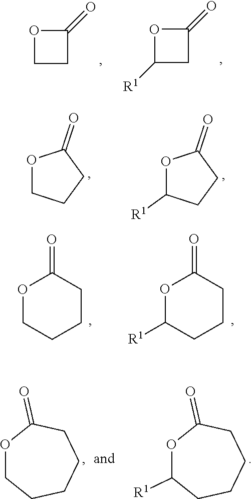

In some aspects, the polymer is at least partially crosslinked. In some aspects, the polymer is substantially crosslinked. In some aspects, the polymer is at least partially crosslinked with a divinyl ether.

In some aspects, the divinyl ether comprises a compound of Formula (III-a):

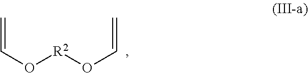

wherein all variables are as defined herein.

In some aspects, the polymer further comprises a hydrolysis stabilizer. The “hydrolysis stabilizer,” as described herein, refers to any number of additives that may be known in the art as suitable for reducing the degradation or breakdown of polyester polymers by hydrolysis. In some aspects, the hydrolysis stabilizer comprises an amine. In particular aspects, the hydrolysis stabilizer comprises a trialkyl amine, such as triethyl amine.

In some aspects, the polymer is healable. By “healable,” as used herein, is meant that the polymer is capable of having damage repaired (such as cracks, etc.) due to the reformation and exchange of covalent bonds within the polymer. In some aspects, the polymer is self-healable, i.e., capable of being repaired without human intervention.

In some aspects, the polymer has a ceiling temperature of less than about 300° C. By “ceiling temperature,” as used herein, is meant the temperature wherein the rate of polymerization and depolymerization of the polymer are substantially equal. In some aspects, the polymer has a ceiling temperature of less than about 275° C., less than about 250° C., less than about 225° C., or less than about 200° C.

In some independent occurrences of Z, Z is selected from fluoro, chloro, bromo, and iodo.

In some independent occurrences of Z, Z is cyano.

In some independent occurrences of Z, Z is azido.

In some independent occurrences of Z, Z is oxo.

In some independent occurrences of Z, Z is selected from methyl, ethyl, n-propyl, isopropyl, n-butyl, isobutyl, sec-butyl, t-butyl, n-pentyl, isopentyl, tert-pentyl, neopentyl, n-hexyl, 2-methylpentane, 3-methylpentane, 2,2-dimethylbutane, and 2,3-dimethylbutane.

In some independent occurrences of Z, Z is selected from trifluoromethyl, trifluoroethyl, and hexafluoroisopropyl.

In some independent occurrences of Z, Z is selected from ethenyl and propenyl.

In some independent occurrences of Z, Z is selected from ethynyl, propynyl, and propargyl.

In some independent occurrences of Z, Z is selected from cyclopropyl, cyclobutyl, cyclopentyl, cyclohexyl, and cycloheptyl.

In some independent occurrences of Z, Z is selected from pyrrolidinyl, imidazolidinyl, piperidinyl, pyrrolinyl, azetidinyl, piperazinyl, pyrazolidinyl, morpholinyl, tetrahydrofuranyl, tetrahydropyranyl, thiazolidinyl, indolinyl, and isoindolinyl.

In some independent occurrences of Z, Z is selected from phenyl, 1-naphthyl, and 2-naphthyl.

In some independent occurrences of Z, Z is selected from pyridinyl, imidazolyl, imidazopyridinyl, pyrimidinyl, pyrazolyl, triazolyl, pyrazinyl, furyl, thienyl, isoxazolyl, thiazolyl, oxadiazolyl, oxazolyl, pyrrolyl, quinolinyl, isoquinolinyl, indolyl, benzimidazolyl, benzofuranyl, indazolyl, indolizinyl, phthalazinyl, pyridazinyl, triazinyl, isoindolyl, pteridinyl, purinyl, thiadiazolyl, furazanyl, benzofurazanyl, benzothiophenyl, benzothiazolyl, benzoxazolyl, quinazolinyl, quinoxalinyl, naphthyridinyl, and furopyridinyl. In some independent occurrences of Z, Z is R^{x}O—, wherein R^{x} is selected from hydrogen, methyl, ethyl, isopropyl, trifluoromethyl, cyclopropyl, cyclobutyl, cyclopentyl, cyclohexyl, and phenyl.

In some independent occurrences of Z, Z is R^{x}S—, wherein R^{x} is selected from hydrogen, methyl, ethyl, isopropyl, trifluoromethyl, cyclopropyl, cyclobutyl, cyclopentyl, cyclohexyl, and phenyl.

In some independent occurrences of Z, Z is (R^{x}R^{y}N)—, wherein R^{x} and R^{y} are independently selected from hydrogen, methyl, ethyl, isopropyl, trifluoromethyl, cyclopropyl, cyclobutyl, cyclopentyl, cyclohexyl, and phenyl.

In some independent occurrences of Z, Z is R^{x}O—C(O)—, wherein R^{x} is selected from hydrogen, methyl, ethyl, isopropyl, trifluoromethyl, cyclopropyl, cyclobutyl, cyclopentyl, cyclohexyl, and phenyl.

In some independent occurrences of Z, Z is R^{x}S—C(O)—, wherein R^{x} is selected from hydrogen, methyl, ethyl, isopropyl, trifluoromethyl, cyclopropyl, cyclobutyl, cyclopentyl, cyclohexyl, and phenyl.

In some independent occurrences of Z, Z is (R^{x}R^{y}N)—C(O)—, wherein R^{x} and R^{y} are independently selected from hydrogen, methyl, ethyl, isopropyl, trifluoromethyl, cyclopropyl, cyclobutyl, cyclopentyl, cyclohexyl, and phenyl.

In some independent occurrences of Z, Z is R^{x}O—S(O)₂—, wherein R^{x} is selected from hydrogen, methyl, ethyl, isopropyl, trifluoromethyl, cyclopropyl, cyclobutyl, cyclopentyl, cyclohexyl, and phenyl.

In some independent occurrences of Z, Z is (R^{x}R^{y}N)—S(O)₂—, wherein R^{x} and R^{y} are independently selected from hydrogen, methyl, ethyl, isopropyl, trifluoromethyl, cyclopropyl, cyclobutyl, cyclopentyl, cyclohexyl, and phenyl.

In some independent occurrences of Z, Z is R^{z}C(O)—O—, wherein R^{z} is selected from hydrogen, chloro, bromo, —OH, —NH₂, methyl, ethyl, isopropyl, trifluoromethyl, cyclopropyl, cyclobutyl, cyclopentyl, cyclohexyl, and phenyl.

In some independent occurrences of Z, Z is R^{z}C(O)—(R^{x}N)—, wherein R^{x} is selected from hydrogen, methyl, ethyl, isopropyl, trifluoromethyl, cyclopropyl, cyclobutyl, cyclopentyl, cyclohexyl, and phenyl, and wherein R^{z} is selected from hydrogen, chloro, bromo, —OH, —NH₂, methyl, ethyl, isopropyl, trifluoromethyl, cyclopropyl, cyclobutyl, cyclopentyl, cyclohexyl, and phenyl.

In some independent occurrences of Z, Z is R^{z}S(O)₂—O—, wherein R^{z} is selected from hydrogen, chloro, bromo, —OH, —NH₂, methyl, ethyl, isopropyl, trifluoromethyl, cyclopropyl, cyclobutyl, cyclopentyl, cyclohexyl, and phenyl.

In some independent occurrences of Z, Z is R^{z}S(O)₂—(R^{x}N)—, wherein R^{x} is selected from hydrogen, methyl, ethyl, isopropyl, trifluoromethyl, cyclopropyl, cyclobutyl, cyclopentyl, cyclohexyl, and phenyl, and wherein R^{z} is selected from hydrogen, chloro, bromo, —OH, —NH₂, methyl, ethyl, isopropyl, trifluoromethyl, cyclopropyl, cyclobutyl, cyclopentyl, cyclohexyl, and phenyl.

In some independent occurrences of Z, Z is R^{z}C(O)—, wherein R^{z} is selected from hydrogen, chloro, bromo, —OH, —NH₂, methyl, ethyl, isopropyl, trifluoromethyl, cyclopropyl, cyclobutyl, cyclopentyl, cyclohexyl, and phenyl.

In some independent occurrences of Z, Z is R^{z}S(O)—, wherein R^{z} is selected from hydrogen, chloro, bromo, —OH, —NH₂, methyl, ethyl, isopropyl, trifluoromethyl, cyclopropyl, cyclobutyl, cyclopentyl, cyclohexyl, and phenyl.

In some independent occurrences of Z, Z is R^{z}S(O)₂—, wherein R^{z} is selected from hydrogen, chloro, bromo, —OH, —NH₂, methyl, ethyl, isopropyl, trifluoromethyl, cyclopropyl, cyclobutyl, cyclopentyl, cyclohexyl, and phenyl.

In some aspects, an article is provided comprising a polymer described herein. Representative examples of such articles include but are not limited to, a lens, a soft actuator, a sensor, a microfluidic chip, or a moldable article.

### Methods of Manufacture

In another aspect, a method of synthesizing a polymer is also provided. In some aspects, the method comprises reacting a polyol and an optionally substituted lactone to form a polylactone. In some aspects, the method further comprises crosslinking the polylactone to form the polymer.

In some aspects, reacting a polyol and an optionally substituted lactone occurs in the presence of a catalyst. The catalyst may be any catalyst recognized as suitable for use in ring-opening polymerizations, in particular, ring-opening polymerizations of lactones. In some aspects, the catalyst comprises an acid catalyst. In some aspects, the acid catalyst comprises a phosphoric acid derivative. In some aspects, the acid catalyst comprises diphenyl phosphate.

In some aspects, the method further comprises treating the polymer with a hydrolysis stabilizer. Hydrolysis stabilizers, particularly those useful for polyester polymers, are known in the art. In some aspects, the hydrolysis stabilizer comprises an amine. In some aspects, the hydrolysis stabilizer comprises a trialkyl amine, such as triethyl amine. In some aspects, the hydrolysis stabilizer may be delivered in the form of a solution. In some aspects, the hydrolysis stabilizer is delivered as an alcohol solution.

Any polyol as previously described herein may be considered suitable for use in the disclosed methods. In particular aspects, the polyol comprises a compound of Formula (I-a):

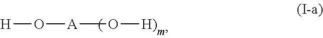

wherein all variables are as defined herein.

In some particular aspects, the polyol comprises

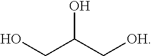

Any optionally substituted lactone described herein may be considered suitable for use in the disclosed methods. In some aspects, the optionally substituted lactone comprises a compound of Formula (II-a):

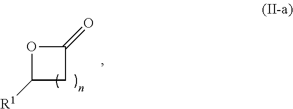

wherein all variables are as defined herein.

In some aspects, the polylactone is at least partially crosslinked with a divinyl ether.

In some aspects, the divinyl ether comprises a compound of Formula (III-a):

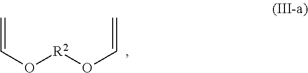

wherein all variables are as defined herein.

Variations on compounds used in the processes described herein can include the addition, subtraction, or movement of various constituents as described for each compound. Similarly, when one or more chiral centers are present in a molecule, the chirality of the molecule can be changed. Additionally, the synthesis of the compounds used in these processes can involve the protection of various chemical groups, and further, the compounds prepared by the disclosed processes may be subsequently deprotected as appropriate. The use of protection and deprotection and the selection of appropriate protecting groups would be readily known to one skilled in the art. “Protecting group”, as used herein, refers to any convention functional group that allows one to obtain chemoselectivity in a subsequent chemical reaction. Protecting groups are described, for example, in Peter G. M. Wuts, Greene's Protective Groups in Organic Synthesis, 5^{th} Ed., Wiley & Sons, 2014. For a particular compound and/or a particular chemical reaction, a person skilled in the art knows how to select and implement appropriate protecting groups and their associated synthetic methods. Examples of carboxyl protecting groups include C₁-C₆ alkoxy groups, such as methyl, ethyl, and t-butyl. Examples of alcohol protecting groups include benzyl, trityl, silyl ethers, and the like.

The described processes, or reactions to produce the compounds used in the described processes, can be carried out in solvents indicated herein or in solvents which can be selected by one of skill in the art of organic synthesis. Solvents can be substantially nonreactive with the starting materials (reactants), intermediates, or products under the conditions at which the reaction is carried out, i.e., temperature and pressure. Reactions can be carried out in one solvent or a mixture of more than one solvent. Product or intermediate formation can be monitored according to any suitable method known in the art. For example, product formation can be monitored by spectroscopic means, such as nuclear magnetic resonance spectroscopy (e.g., ¹H and ¹³C), infrared spectroscopy, spectrophotometry (e.g., UV-visible), mass spectrometry, or chromatography such as high-performance liquid chromatography (HPLC) or thin layer chromatography (TLC).

In another aspect, a polymer is provided prepared by a method described herein.

### ADDITIONAL ASPECTS

In view of the described compositions, articles, and methods, certain more particular aspects of the disclosure are described below. These particularly recited aspects should not, however, be interpreted to have any limiting effect on any different claims containing different or more general teachings described herein or that the “particular” aspects are somehow limited in some way other than the inherent meanings of the language and formulae literally used therein.

Aspect 1. A polymer comprising:
one or more constitutional units derived from a polyol; and
one or more constitutional units derived from an optionally substituted lactone;
wherein the polymer is at least partially crosslinked.

Aspect 2. The polymer of aspect 1, wherein the polymer is a vitrimer.

Aspect 3. The polymer of aspect 1 or aspect 2, wherein the one or more constitutional units derived from a polyol comprise a structure of Formula (I):

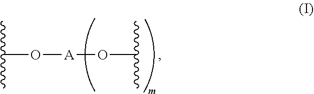

wherein:

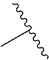

is a point of attachment of the structure of Formula (I) within the polymer; m is an integer selected from 1 to 5;
A is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

Aspect 4. The polymer of aspect 3, wherein m is 2.

Aspect 5. The polymer of aspect 3 or aspect 4, wherein A is C₁-C₁₂ alkyl.

Aspect 6. The polymer of any one of aspects 3-5, wherein the one or more constitutional units derived from a polyol comprises

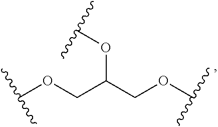 [SMILES: *OCC(CO*)O*]

wherein

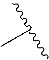

is a point of attachment within the polymer.

Aspect 7. The polymer of any one of aspects 1-6, wherein one or more constitutional units derived from an optionally substituted lactone comprise a structure of Formula (II):

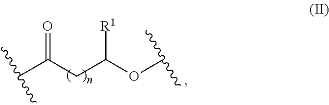

wherein:

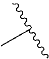

is a point of attachment of the structure of Formula (II) within the polymer;
n is an integer selected from 1 to 4;
R¹ is selected from hydrogen, C₁-C₁₂ alkyl, C₁-C₁₂ haloalkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, and 5- to 10-membered monocyclic or bicyclic heteroaryl, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

Aspect 8. The polymer of aspect 7, wherein n is 3.

Aspect 9. The polymer of aspect 7 or aspect 8, wherein R¹ is C₁-C₁₂ alkyl.

Aspect 10. The polymer of any one of aspects 1-9, wherein the one or more constitutional units derived from a polyol and the one or more constitutional units derived from an optionally substituted lactone are directly connected.

Aspect 11. The polymer of aspect 1 or aspect 2, comprising one or more constitutional units having the structure:

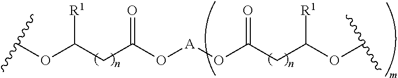

Wherein:

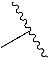

is a point of attachment of the structure of Formula (I) within the polymer;
   m is an integer selected from 1 to 5;
n is an integer selected from 1 to 4;
A is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
R¹ is selected from hydrogen, C₁-C₁₂ alkyl, C₁-C₁₂ haloalkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, and 5- to 10-membered monocyclic or bicyclic heteroaryl, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

Aspect 12. The polymer of any one of aspects 1-11, wherein the polymer is at least partially crosslinked with a divinyl ether.

Aspect 13. The polymer of aspect 12, further comprising one or more crosslinking units derived from the divinyl ether.

Aspect 14. The polymer of aspect 13, wherein the one or more crosslinking units comprise a structure of Formula (III):

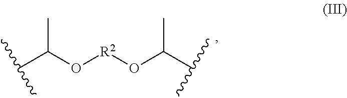

wherein:

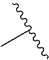

is a point of attachment of the structure of Formula (III) within the polymer;
R² is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

Aspect 15. The polymer of aspect 14, wherein R² is selected from C₁-C₁₂ alkyl, C₃-C₆ cycloalkyl, and 6- to 10-membered monocyclic or bicyclic aryl, or a combination thereof.

Aspect 16. The polymer of aspect 14 or aspect 15, wherein R² is

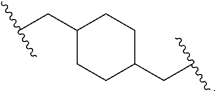 [SMILES: *CC1CCC(C*)CC1]

Aspect 17. A polymer formed from:
one or more monomers comprising a polyol; and
one or more monomers comprising an optionally substituted lactone;
wherein the polymer is at least partially crosslinked.

Aspect 18. The polymer of aspect 17, wherein the polymer is a vitrimer.

Aspect 19. The polymer of aspect 17 or aspect 18, wherein the one or more monomers comprising a polyol comprise a compound of Formula (I-a):

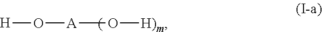

wherein:
m is an integer selected from 1 to 5;
A is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

Aspect 20. The polymer of aspect 19, wherein m is 2.

Aspect 21. The polymer of aspect 19 or aspect 20, wherein A is C₁-C₁₂ alkyl.

Aspect 22. The polymer of any one of aspects 19-21, wherein the one or more monomers comprising a polyol comprise

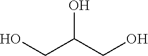

Aspect 23. The polymer of any one of aspects 17-22, wherein one or more monomers comprising an optionally substituted lactone comprise a compound of Formula (II-a):

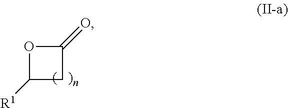

wherein:
n is an integer selected from 1 to 4;
R¹ is selected from hydrogen, C₁-C₁₂ alkyl, C₁-C₁₂ haloalkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, and 5- to 10-membered monocyclic or bicyclic heteroaryl, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

Aspect 24. The polymer of aspect 23, wherein n is 3.

Aspect 25. The polymer of aspect 23 or aspect 24, wherein R¹ is C₁-C₁₂ alkyl.

Aspect 26. The polymer of any one of aspects 17-25, wherein the polymer is at least partially crosslinked with a divinyl ether.

Aspect 27. The polymer of aspect 26, wherein the divinyl ether comprises a compound of Formula (III-a):

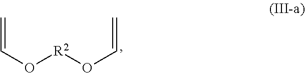

wherein:
R² is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

Aspect 28. The polymer of aspect 27, wherein R² is selected from C₁-C₁₂ alkyl, C₃-C₆ cycloalkyl, and 6- to 10-membered monocyclic or bicyclic aryl, or a combination thereof.

Aspect 29. The polymer of aspect 27 or aspect 28, wherein R² is

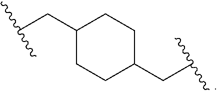 [SMILES: *CC1CCC(C*)CC1]

Aspect 30. The polymer of any one of aspects 1-29, further comprising a hydrolysis stabilizer.

Aspect 31. The polymer of aspect 30, wherein the hydrolysis stabilizer comprises an amine.

Aspect 32. The polymer of aspect 30 or aspect 31, wherein the hydrolysis stabilizer comprises a trialkyl amine, such as triethyl amine.

Aspect 33. The polymer of any one of aspects 1-32, wherein the polymer is healable.

Aspect 34. The polymer of any one of aspects 1-33, wherein the polymer has a ceiling temperature of less than about 300° C.

Aspect 35. An article comprising a polymer of any one of aspects 1-34.

Aspect 36. The article of aspect 35, wherein the article is a lens, a soft actuator, a sensor, a microfluidic chip, or a moldable article.

Aspect 37. A method of synthesizing a polymer comprising:
reacting a polyol and an optionally substituted lactone to form a polylactone; and
crosslinking the polylactone to form the polymer.

Aspect 38. The method of aspect 37, wherein reacting a polyol and an optionally substituted lactone occurs in the presence of a catalyst.

Aspect 39. The method of aspect 38, wherein the catalyst comprises an acid catalyst.

Aspect 40. The method of aspect 39, wherein the acid catalyst comprises diphenyl phosphate.

Aspect 41. The method of any one of aspects 37-40, further comprising treating the polymer with a hydrolysis stabilizer.

Aspect 42. The method of aspect 41, wherein the hydrolysis stabilizer comprises an amine.

Aspect 43. The method of aspect 41 or aspect 42, wherein the hydrolysis stabilizer comprises a trialkyl amine, such as triethyl amine.

Aspect 44. The method of any one of aspects 41-43, wherein the hydrolysis stabilizer is delivered as an alcohol solution.

Aspect 45. The method of any one of aspects 37-44, wherein the polyol comprises a compound of Formula (I-a):

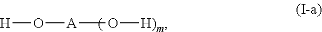

wherein:
m is an integer selected from 1 to 5;
A is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

Aspect 46. The method of aspect 45, wherein m is 2.

Aspect 47. The method of aspect 45 or aspect 46, wherein A is C₁-C₁₂ alkyl.

Aspect 48. The method of any one of aspects 45-47, wherein the polyol comprises

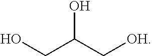

Aspect 49. The method of any one of aspects 37-48, wherein the optionally substituted lactone comprises a compound of Formula (II-a):

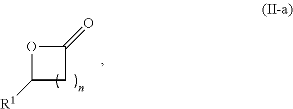

wherein:
n is an integer selected from 1 to 4;
R¹ is selected from hydrogen, C₁-C₁₂ alkyl, C₁-C₁₂ haloalkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, and 5- to 10-membered monocyclic or bicyclic heteroaryl, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

Aspect 50. The method of aspect 49, wherein n is 3.

Aspect 51. The method of aspect 49 or aspect 50, wherein R¹ is C₁-C₁₂ alkyl.

Aspect 52. The method of any one of aspects 37-51, wherein the polylactone is at least partially crosslinked with a divinyl ether.

Aspect 53. The method of aspect 52, wherein the divinyl ether comprises a compound of Formula (III-a):

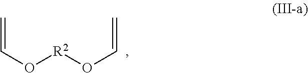

wherein:
R² is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆alkyl, C₁-C₆haloalkyl, C₂-C₆alkenyl, C₂-C₆alkynyl, (C₃-C₇cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

Aspect 54. The method of aspect 53, wherein R² is selected from C₁-C₁₂ alkyl, C₃-C₆ cycloalkyl, and 6- to 10-membered monocyclic or bicyclic aryl, or a combination thereof.

Aspect 55. The method of aspect 53 or aspect 54, wherein R² is

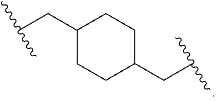 [SMILES: *CC1CCC(C*)CC1]

Aspect 56. A polymer prepared by the method of any one of aspects 37-55.

A number of aspects of the disclosure have been described. Nevertheless, it will be understood that various modifications may be made without departing from the spirit and scope of the disclosure. Accordingly, other aspects are within the scope of the following claims.

By way of non-limiting illustration, examples of certain aspects of the present disclosure are given below.

### EXAMPLES

The following examples are set forth below to illustrate the compositions, articles, and methods claimed herein, along with associated methods and results according to the disclosed subject matter. These examples are not intended to include all aspects of the subject matter disclosed herein but rather to illustrate representative methods and results. These examples are not intended to exclude equivalents and variations of the present disclosure, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions, that can be used to optimize the product purity and yield obtained from the described process. Only reasonable and routine experimentation will be required to optimize such process conditions.

### One-Pot Synthesis of Depolymerizable δ-Lactone Based Vitrimers

This example describes a depolymerizable vitrimer that allows both reprocessability and monomer recovering by a simple and scalable one-pot two-step synthesis of vitrimers from cyclic lactones. Biobased δ-valerolactone with alkyl substituents (δ-lactone) has low ceiling temperature, thus their ring opening polymerized aliphatic polyesters are capable to depolymerize back to monomers. In this example, the amorphous poly(δ-lactone) is solidified into an elastomer (i.e. δ-lactone vitrimer) by vinyl ether cross-linker with dynamic acetal linkages, giving the merits of reprocessing and healing. The thermolysis of the bulk δ-lactone vitrimer at 200° C. can recover 85-90 wt % of the material, allowing reuse without losing value and achieving a successful closed-loop life cycle. We further demonstrate that this new vitrimer has excellent properties for serving as a biobased and sustainable replacement of conventional soft elastomers for various applications such as lens, mold material, soft robots, and microfluidic devices.

### Introduction

To leverage the advantages of the reprocessability of vitrimers and depolymerizability of poly(δ-lactone), we anticipated that a depolymerizable vitrimer could be achieved if a dynamic linkage can be used to crosslink the otherwise viscous liquid-like poly(δ-lactone). Depolymerization of low-ceiling-temperature poly(δ-lactone) relies on the backbite of hydroxyl groups. Linkages or crosslinking at the hydroxyl site significantly inhibit such depolymerization reactions and increase stability. Here, we present the use of degradable acetal linkages to crosslink poly(δ-lactone). The acetal group is a pH-responsive group that is highly stable under neutral and basic conditions at room temperature, but rapidly hydrolyzes into aldehyde and alcohol under mild acidic conditions or elevated temperatures. The recovered hydroxyl groups then facilitate the depolymerization to monomer of the poly(δ-lactone). Through this strategy, we have developed acetal crosslinked δ-lactone vitrimers, which possess the dynamic properties of vitrimers while also being able to be depolymerized under mild conditions with a high recycling to monomer ratio. These vitrimers have excellent mechanical and optical properties and can be reprocessed, recycled, and depolymerized to recover virgin-quality monomers for reuse, achieving closed-loop life cycles. In addition to their sustainability benefits, the δ-lactone vitrimers can serve as a sustainable replacement for silicones or polydimethylsiloxane (PDMS), which are widely used in lenses, soft mold materials, soft robotics, and microfluidic devices but are not recyclable.

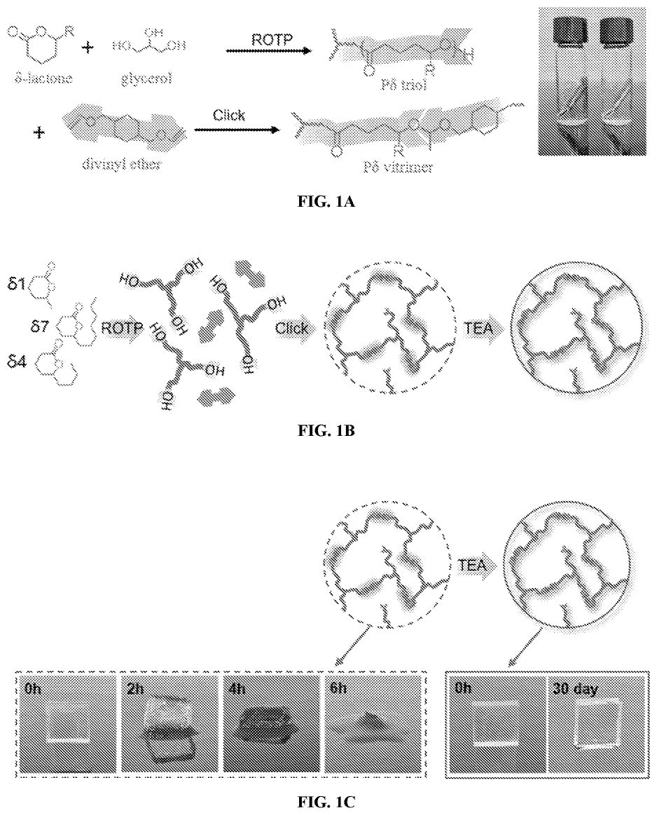

The inherent degradability of aliphatic polyesters from alkyl-substituted δ-lactone was utilized to crosslink with divinyl ether via a “click” reaction between hydroxyl and vinyl in a one-pot synthesis (as shown in FIG. 1A). Dynamic metathesis of acetals^{43,44} is a thermally responsive exchange reaction but is not commonly used in vitrimer design due to hydrolytic degradation. To overcome this limitation, we exploited an organobase as a stabilizer to suppress hydrolysis, which significantly increases the stability of acetal linkages under ambient conditions while still permitting cleavage at elevated temperatures to recover the hydroxyl groups. Ultimately, 85-90 wt % of the δ-lactone vitrimers can be depolymerized into high-purity monomers for reuse. The proposed polymer design thus opens a new route to develop sustainable alternatives for a wide range of soft material applications.

### Results and Discussion

### Synthetic Chemistries for Degradable Pδ Vitrimers

In this example, the degradable poly(δ-lactone) (Pδ) vitrimer was synthesized in a simple one-pot, two-step procedure as illustrated in FIG. 1A. First, glycerol was employed as an initiator to produce the 3-arm Pδ triol, resulting in a viscous polymer liquid. Second, a divinyl ether (1,4-Cyclohexanedimethanol divinyl ether) was added directly to crosslink the Pδ triol. The properties of the Pδ triols are summarized in Table 1. All feedstocks were completely utilized in the reaction without any byproduct. The final resultant thermoset Pδ vitrimer enabled thermal depolymerization under mild condition (~200° C.).

TABLE 1
Property of Pδ triols.

| | | Theory | SEC | | | | | |
|---|---|---|---|---|---|---|---|---|
| | | Mw | Mw | SEC | Conversion | Tg | Td_{5%} | Tc |
| | [M]/[I]/[DPP] | g/mol | g/mol | PDI | % | ° C. | ° C. | ° C. |
| P-δ1 | 12:1:0.12 | 1461 | 1854 | 1.22 | 91.4 | −51.8 | 211.9 | 170 |
| P-δ4 | 12:1:0.12 | 1966 | 2629 | 1.25 | 90.7 | −61.1 | 191.8 | 140 |
| P-δ7 | 12:1:0.12 | 2468 | 3348 | 1.20 | 89.5 | −65.2 | 169.7 | 130 |

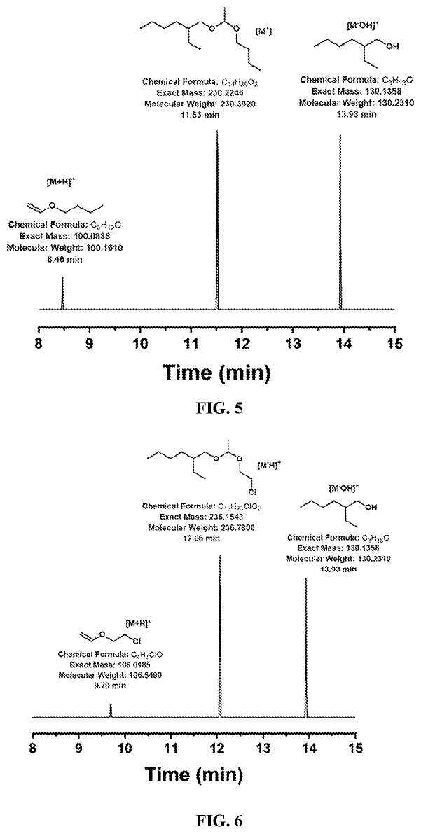

The organocatalyst diphenyl phosphate (DPP) is an efficient acid catalyst for controlled ROTP of δ-lactone, and we found it can also effectively catalyze the click reaction between vinyl ethers and alcohols, as demonstrated with the model reactions (details below and in FIGS. 5 to 7). Thus, the ROTP synthesized Pδ can be used directly for crosslinking without any post-treatment. The divinyl ether crosslinker was then added into Pδ in a certain molar ratio respective to the hydroxyl groups. The reaction was confirmed by FTIR spectra (FIG. 8). The characteristic peak intensity of O—H stretch at ~3400 cm⁻¹ gradually decreased with increasing crosslinker quantity, along with the characteristic C═C stretch at ~1608 cm⁻¹, indicating the successful reaction between the Pδ and the divinyl ether. With excess crosslinker, the extra vinyl ether tended to homopolymerize^{4S}, which turned the sample from colorless to light yellow, as shown in FIG. 1A. To avoid this side reaction, a slight stoichiometric excess of alcohol (r=0.9 vinyl group: hydroxyl group in molar ratio) was employed, and the obtained sample was colorless and highly transparent. Moreover, the remaining unreacted hydroxyl moieties can facilitate the depolymerizability of Pδ. The gel fraction after the swelling test with acetone is directly indicative of the crosslinked network. All tested samples with the above stoichiometric ratio possessed high gel content ranging from 92% to 95%.

FIG. 1B illustrates the overall synthetic route for Pδ vitrimers. Three different S-lactone monomers with alkyl substituent lengths 1 (δ1), 4(δ4) and 7(δ7) were compared.

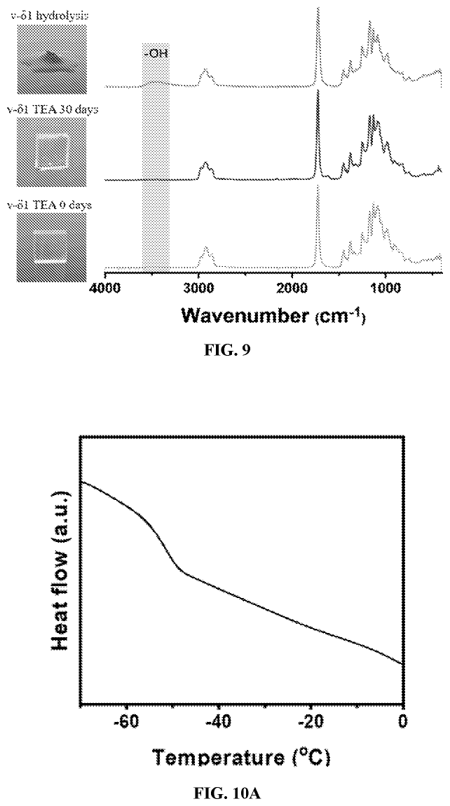

The Pδ vitrimer network was formed through the aforementioned one-pot, two-step reaction sequence, and the curing was efficient under a nitrogen atmosphere. The synthesized Pδ vitrimers were labeled as v-δ1, v-δ4 and v-δ7 according to their respective lactone monomers. It is noted that the dynamic metathesis of acetals^{43,44} is a thermally responsive exchange reaction. Although several acetal-based vitrimer polymers were recently reported^{46,47}, they are still not commonly used due to the instability of hydrolytic degradation of acetal linkages under ambient conditions⁴⁸. As shown in FIG. 1C, the cured Pδ vitrimer degraded back to Pδ within 6 hours. FTIR results confirmed the —OH peak was recovered after the hydrolysis of acetal linkage (FIG. 9). To address this issue, a soaking procedure was developed in the presence of triethylamine (TEA) to suppress hydrolysis. The organic weak base can neutralize the acid catalyst DPP to form a stable triethylamine salt. Simply soaking the cured Pδ vitrimers in 1 wt % TEA in isopropyl alcohol (IPA) solution effectively preserved them from hydrolysis of acetal groups. The treated Pδ vitrimers were stable for more than one month without degradation in an open air condition with a humidity of 14-16%.

### Thermal and Mechanical Properties of Pδ Vitrimers

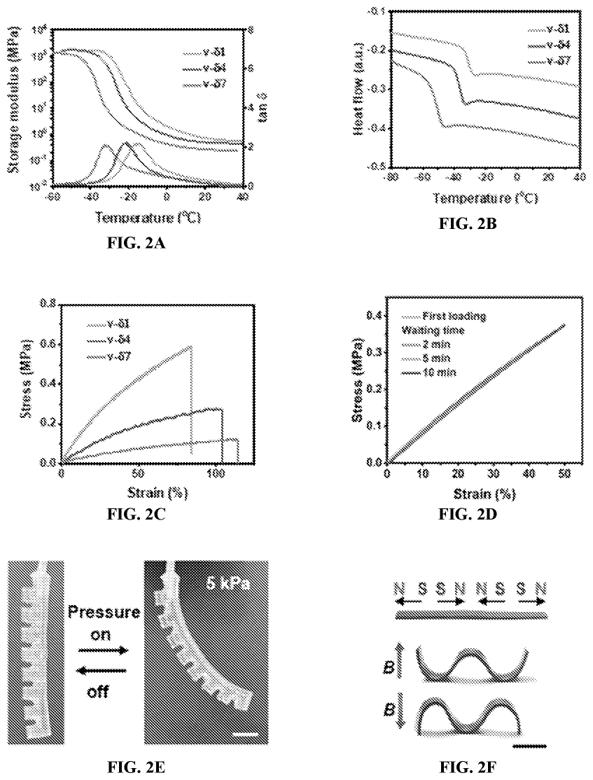

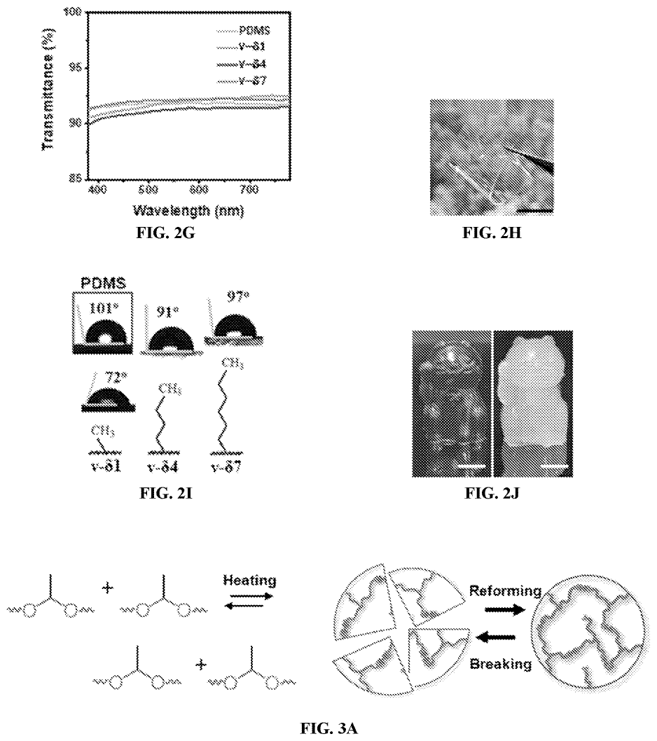

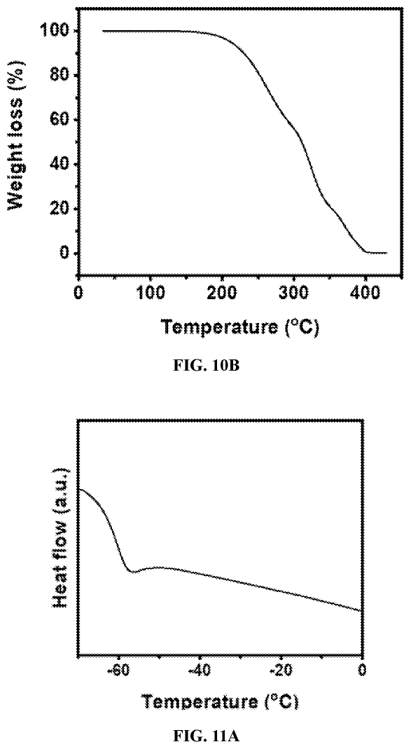

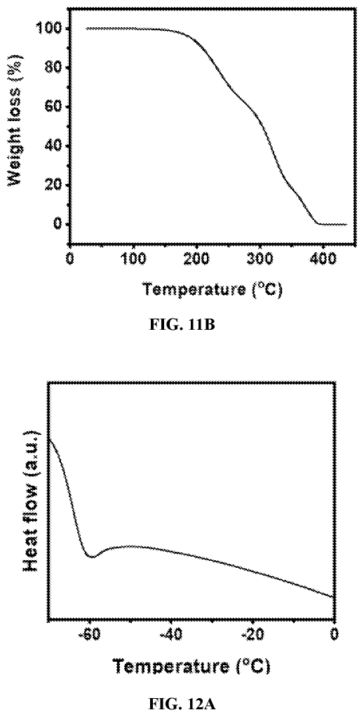

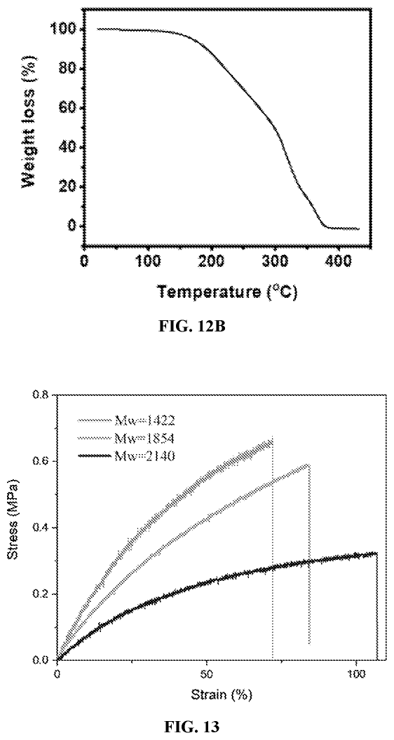

PDMS is one of the most used soft elastomers but is non-recyclable. Here, we evaluated the properties of synthesized Pδ vitrimers to validate the potential to be used as a sustainable substitute of PDMS. Since the alkyl substituent length could affect the thermomechanical and depolymerization behaviors of the Pδ vitrimers, the influence of their side chain lengths on these properties was investigated. Dynamic mechanical analysis (DMA) results of the Pδ vitrimers displayed typical thermoset behaviors with a plateau of storage modulus above the glass transition temperature (T_{g}), as shown in FIG. 2A. Increasing the side chain length resulted in lower T_{g} and lower storage modulus. The crosslinking densities were also quantitatively confirmed from the storage modulus at the rubbery plateau region, indicating that longer side chains impart lower crosslink density. The rigidity of their chain segment generally determined T_{g} of crosslinked polymers. Owing to the amorphous and flexible Pδ, the Pδ vitrimers possessed T_{g} below 0° C. as shown by the tan S peaks in FIG. 2A. Longer side chains decreased the T_{g} of crosslinked Pδ vitrimers, consistent with the T_{g} of linear Pδ counterparts (as shown in FIGS. 10A-10B, 11A-11B, and 12A-12B). The T_{g} measured from differential scanning calorimetry (DSC) presented the same trend as shown in FIG. 2B, with −30.8° C., −36.4° C., and −50.8° C. for v-δ1, v-δ4, and v-δ7 respectively. All detailed data is presented in Table 2.

TABLE 2
Properties of Pδ vitrimers.

| | Young's | Tensile | Elongation | Swelling | Gel | T_{g} | T_{g} | |
|---|---|---|---|---|---|---|---|---|
| | modulus | strength | at break | ratio | fraction | (DMA) | (DSC) | T_{d5%} |
| | MPa | MPa | % | % | % | ° C. | ° C. | ° C. |
| v-δ1 | 1.24 | 0.58 | 84.2 | 72 | 95.2 | −15.7 | −30.8 | 196 |
| v-δ4 | 0.66 | 0.27 | 103.8 | 77 | 94.6 | −21.8 | −36.4 | 181 |
| v-δ7 | 0.27 | 0.12 | 114.2 | 83 | 92.3 | −32.2 | −50.8 | 176 |

The Pδ vitrimers exhibited typical elastomeric stress-strain behaviors with Young's moduli from 0.27 to 1.24 MPa (FIG. 2C). Increasing side chain length resulted in a softer elastomer with higher stretchability: v-δ1 can be stretched more than 80% before failure, while v-δ7 can be stretched more than 110%. The properties can be easily modulated with different δ-lactone monomers or molecular weight to adapt to different applications (FIG. 13). In addition, as shown in FIG. 2D, the loading and unloading curves of v-δ1 are superimposable with negligible hysteresis. It is worth noting that high stretchability and low hysteresis are desirable properties for sensor and actuator applications as they allow faster deformation and recovery. To date, soft materials, such as PDMS, are widely used in soft actuators, which have the advantage of interacting with fragile objects or living organisms; but PDMS is not recyclable due to the chemically crosslinked network.⁴⁹ The excellent mechanical properties of our δ-lactone vitrimers can provide an alternative sustainable replacement of these materials. FIG. 2E shows a pneumatic actuator by using mold-cured v-δ1. The soft actuator by v-δ1 was able to bend by 700 when a very low pressure of 5 KPa was applied.

Another example, as shown in FIG. 2F, is a magnetic soft material fabricated by v-δ1 embedded with 50 wt. % magnetic particles of neodymium magnet (NdFeB). Magnetically responsive actuator enables programmable deformation, controlled by the magnetic field direction and magnitude⁵⁰⁻⁵⁴. Since magnetic fields can penetrate most materials, this type of soft actuator is ideal for enclosed area applications such as targeted drug delivery or minimally invasive surgery⁵⁵⁻⁵⁷. Most of the previous works used silicone or PDMS as the matrix material. Here, the rather soft Pδ vitrimers are very sensitive to the applied stimulus. In FIG. 2F, the magnetic soft material was magnetized first (top photo; N and S are directions of magnetic poles). When an upward magnetic field B=50 mT was applied, the strip bent into a W-shape; when the magnetic field was switched, it bent into an M-shape. In addition, the Pδ vitrimers had the modulus from 0.27 to 1.24 MPa, covering the range of human skin (0.42-0.75 MPa)⁵⁸, which can be potentially further tuned by changing the molecular weight of Pδ or copolymerized with different PSs for skin like actuator or sensor applications.

The amorphous Pδ vitrimers bring not only resiliency but also transparency. All Pδ vitrimers displayed similarly high transparency as commercial PDMS with a transmittance over 90% at the visible wavelength range as shown in FIG. 2G. FIG. 2H shows the as-prepared v-δ1 film, which exhibit high transparency.

We further compared the effect of alky side chain length on the surface property. As the linear alkyl chains were hydrophobic, the long chain v-δ5 and v-δ7 displayed higher hydrophobicity than v-δ1, as indicated by the increasing contact angle from v-δ1 to v-δ7. In addition, v-δ7 possessed similar contact angle as PDMS as shown in FIG. 2I. The softness and hydrophobicity can be used to fabricate v-δ7 based depolymerizable and recyclable molds as replacements to PDMS molds. FIG. 2J shows two lucky cats made of gelatin jelly and silicone rubber that were cured using the same v-δ7 mold. These examples confirmed that Pδ vitrimers possess physical properties similar to PDMS that are flexible and elastic, transparent and hydrophobic, demonstrating the ability as a sustainable substitute of PDMS.

### Reprocessing, Reshaping, and Healing Enabled by Exchange Reactions in Pδ Vitrimers

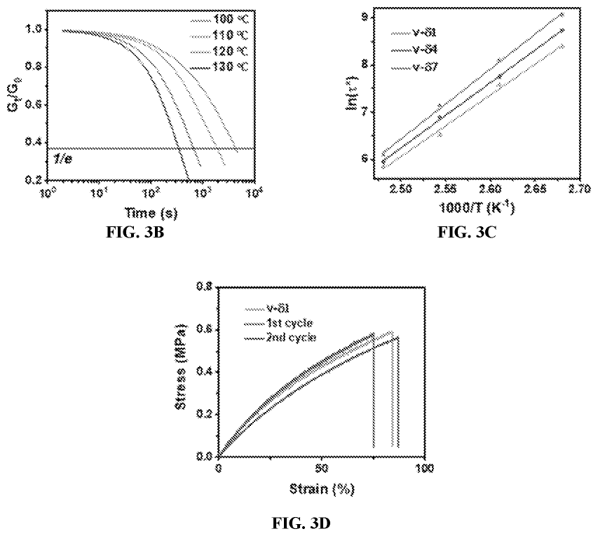

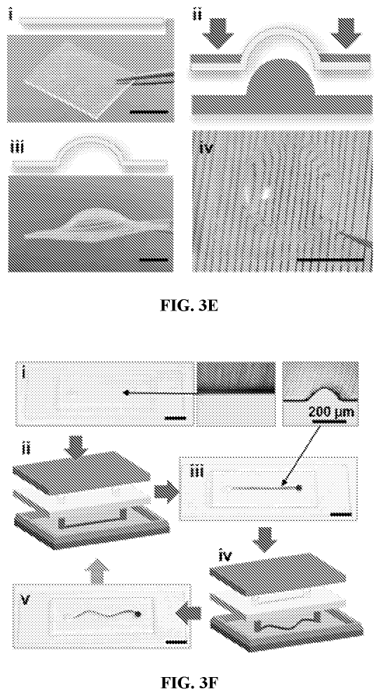

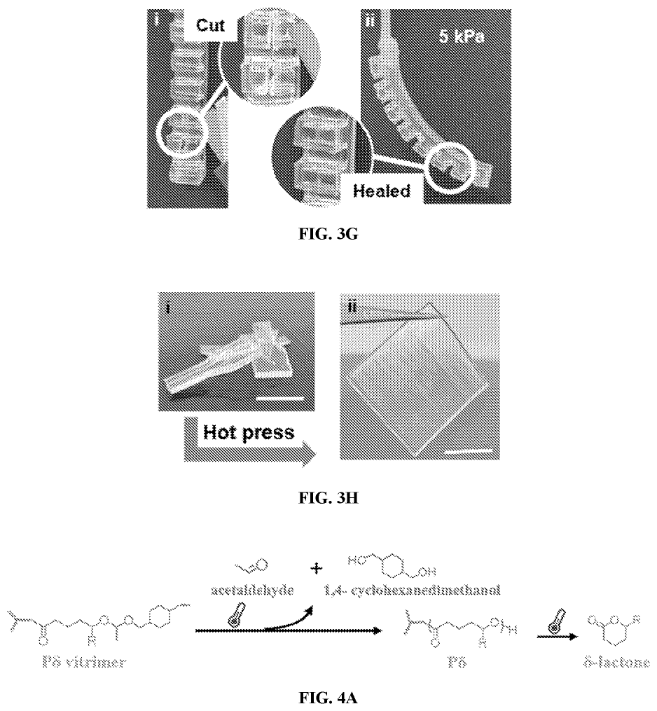

Vitrimers exhibit unique features that allow the network topology rearrangement while maintaining their crosslinking. These features allow them to be welded, remolded, and reprocessed at elevated temperatures. In our Pδ vitrimers, these features were enabled by the acetal metathesis exchange reaction, which is shown schematically in FIG. 3A and further validated with small molecule model reactions (detail in FIGS. 5-7). The dynamic properties of the Pδ vitrimers were evaluated by stress relaxation tests. All Pδ vitrimers reached complete stress relaxation within a relatively short time under a mild temperature between 100 to 130° C. (as shown in FIG. 3B for v-δ1), which validated the exchangeable acetal linkages of the vinyl ether cured Pδ vitrimers. As shown in FIG. 3B, the relaxation modulus decreased exponentially over time and exhibited typical Arrhenius temperature-dependent behavior (351s of 130° C., 681s of 120° C., 1920s of 110° C. and 4371s of 100° C.). The exchange kinetic analysis of the acetal linkage with the Arrhenius equation revealed relatively low activation energy (Eₐ). V-δ1 has the fastest reaction rate and lowest Eₐ of 108.3 KJ/mol, compared with 114.8 KJ/mol and 122.8 KJ/mol for v-δ4 and v-δ7 as shown in FIG. 3C. Higher crosslinking density and reduced steric hindrance were favorable for the exchange reaction,⁵⁹ which was consistent with the experimental observation.

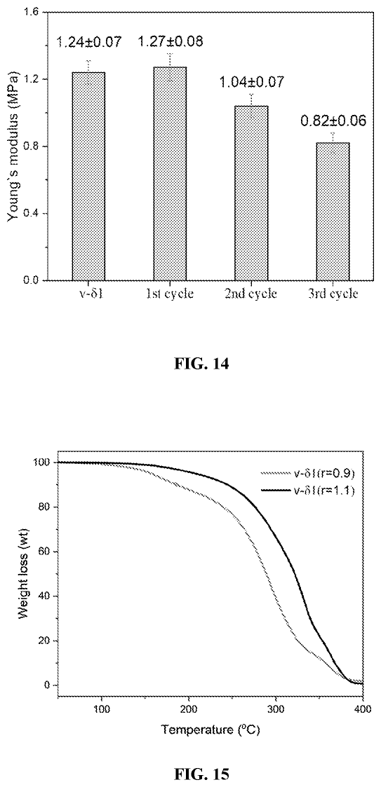

The reprocessability of Pδ vitrimer was validated with a conventional hot-press reprocessing with the broken tensile test samples. The mechanical properties of the reprocessed samples (v-δ1) were compared in FIG. 3D. A slight decrease in modulus on the second time reprocessed sample was observed, possibly due to the slight hydrolytic degradation during the hot pressing in the air. Further reprocessing significantly decreased the properties due to the low thermal stability of the degradable vitrimers (FIG. 14). The dynamic exchange of the acetal linkages allowed the rearrangement of network topology, making the crosslinked Pδ vitrimer malleable. The high transparency of Pδ vitrimer can be potentially utilized as materials for recyclable lenses. In a proof-of-concept demonstration, as shown in FIG. 3E, a 2D flat v-δ1 film (FIG. 3E, panel i) was reshaped using a hemispherical mold at 130° C. for 30 mins (FIG. 3E, panel ii) into a 3D hemisphere shape convex lens (FIG. 3E, panels iii and iv). It offered more flexibility in shape adaptation than regular soft elastomers like PDMS, silicone rubber, or hydrogel. FIG. 3F demonstrated another possible application as remoldable microfluidic chip. The flat v-δ1 sample (FIG. 3F, step i) was hot-stamp imprinted (FIG. 3F, step ii, 130° C. for 30 min) with the predesigned microchannel pattern into a microfluidic chip (FIG. 3F, step ii). It could be rewritten into a different pattern by remolding (FIG. 3F, step iv, 130° C. for 30 min) for a new chip (FIG. 3F. step v).

Another important feature of vitrimers was the exchangeable reaction endowed healability and reprocessability. Soft actuators and sensors are often required in dynamic and complex stress/strain environments. Particularly for soft pneumatic actuators, any puncture damage would cause the loss of their function. Herein, the mold fabricated v-δ1 pneumatic actuator in FIG. 2E was cut by a blade with complete separated damage (as shown in FIG. 3G, panel i), and it can no longer be actuated because of the major leakage. The damaged actuator was then healed in a customized epoxy mold at 130° C. for 30 mins. The separated part was welded airtightly together through surface exchange reactions. The bending deformation was recovered, as demonstrated in FIG. 3G, panel ii. FIG. 3H displayed the reprocessed v-δ1 sample after remolding from the cut small pieces. From these examples, it can be seen that besides having the properties that could be used to serve as a sustainable replacement of PDMS, our Pδ vitrimers also possessed the advantages such as reforming, healing, and reprocessing, which are unavailable in PDMS.

### Depolymerization of Pδ Vitrimers

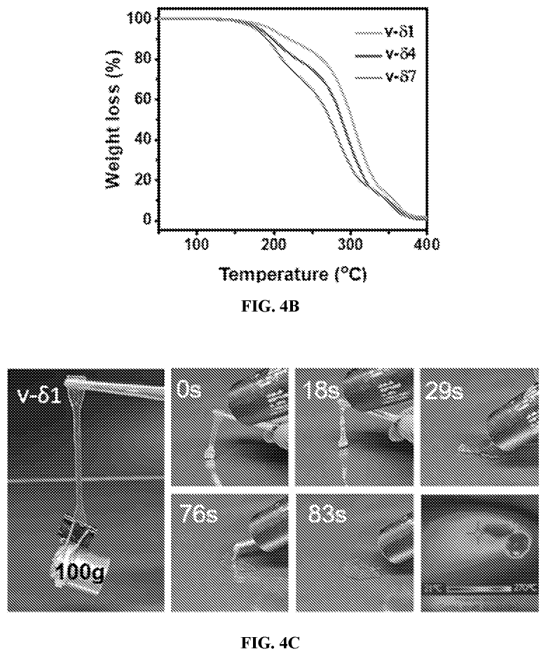

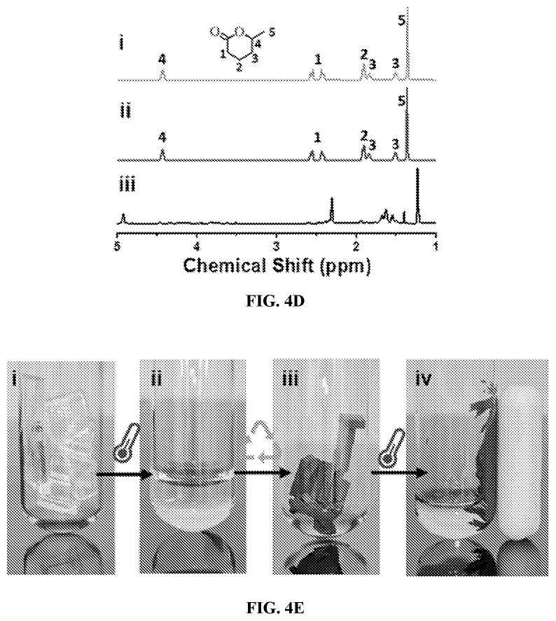

The Pδ vitrimers were able to depolymerize to the original δ-lactone monomers when they were at the end of their service lifetime, such as repeated reprocessing. The depolymerization route of Pδ vitrimer is illustrated in FIG. 4A. The initial degradation temperature Tas % (the temperature for 5% weight loss) was 196° C., 181° C., and 176° C. for v-δ1, vδ-4, and v-7, respectively, when the sample was heated at 10° C./min. Upon heating to 200° C., the acetal cross-linkages started to decompose to 1,4-cyclohexanedimethanol and acetaldehyde and evaporated, resulting in the hydroxyl capped Pδ aliphatic polyester, which can be simultaneously depolymerized and the monomer recovered through the backbiting reactions⁶⁰. Although the degraded crosslinker constitutes only a small proportion of the vitrimers, it can still be recycled and used to synthesize new crosslinker for reuse. The thermal stability of Pδ vitrimers was examined by TGA as shown in FIG. 4B. Moreover, all samples reached nearly 100% weight loss at a temperature below 380° C., due to the evaporation of the resulting small molecules. According to the previous report by Hillmyer et al., the ceiling temperatures for polymers made from δ1, δ4 and δ7 were approximately 170, 140, and 130° C., respectively³⁵. Therefore, the vitrimers with longer alkyl groups were likely to depolymerize at a lower temperature, and the degradation behavior of the crosslinked Pδ vitrimers followed this trend. The acetal linkages started to degrade first and release more free hydroxyl groups on the chain ends of Pδ segments, and then the depolymerization of poly(δ-lactone) occurred. FIG. 4C showed the v-δ1 sample degraded from crosslinked solid elastomer to viscous liquid polymer (FIG. 4D) at a temperature around 200-250° C. with a heat gun, which was due to degradation of the acetal linkage. Rapid degradation of the v-δ1 sample was observed, turning into liquid within 2 minutes by a hot air gun. It's worth noting that as long as the polymer is stable under the application conditions, a lower degradation temperature is favorable for recycling. However, the thermal stability can be increased by tuning the stoichiometric ratio of the crosslinker (FIG. 15).⁶¹

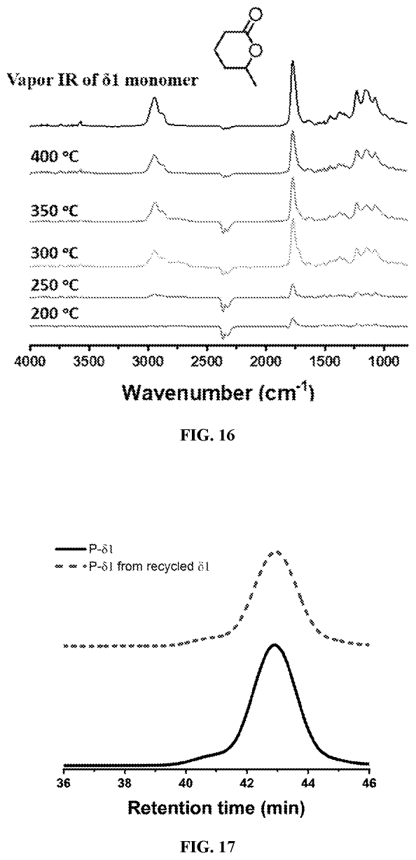

The bulk thermolysis of Pδ vitrimer was also attempted, and all samples can be completely depolymerized at 200° C. in less than one hour. In many previous works using Pδ in copolymer design, the degraded mixture contained a large portion of undepolymerized oligomers^{41,62}. In our approach, the depolymerization of Pδ vitrimers yielded entirely small molecules. Moreover, 85 wt % to 90 wt % of the Pδ vitrimers were successfully recycled back to cyclic δ-lactone monomers, and the ratio can be increased further by increasing the poly(δ-lactone) molecular weight. δ-lactone monomers can be easily recollected with high purity (nearly 100% yield) by distillation under reduced pressure, as confirmed in FIG. 4D. In situ TGA-IR of v-δ1 also directly confirmed the evaporated product was 61 monomer (FIG. 16).

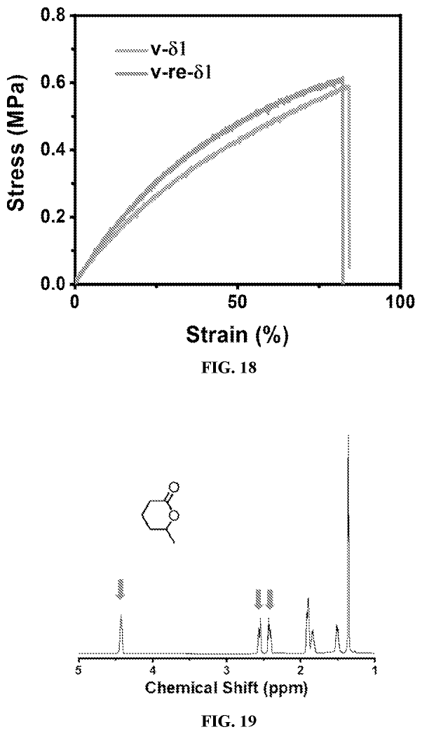

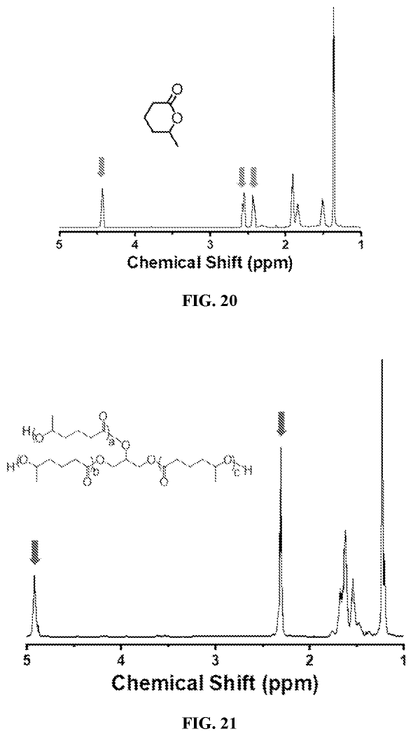

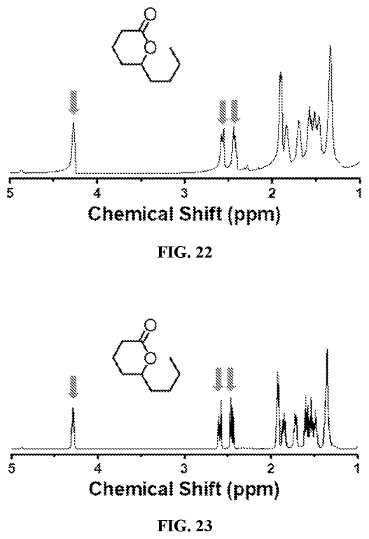

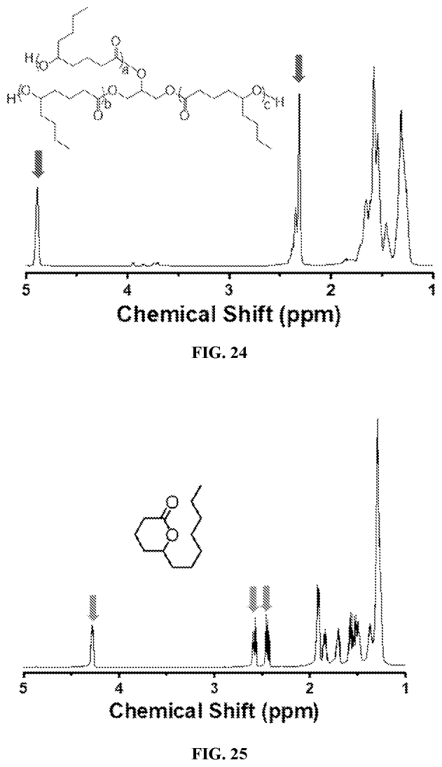

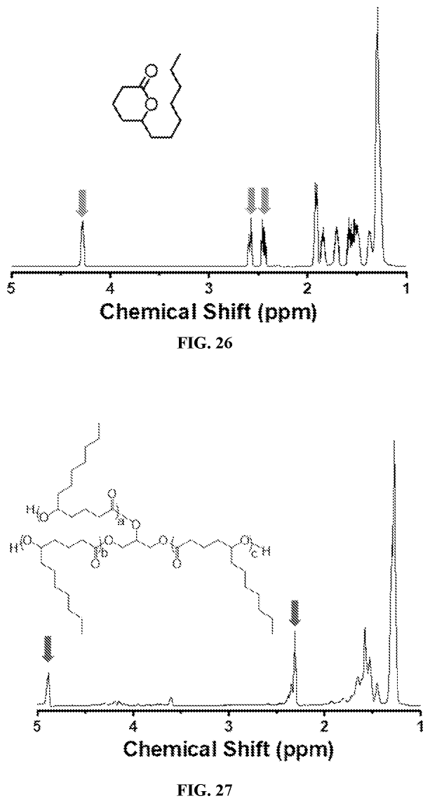

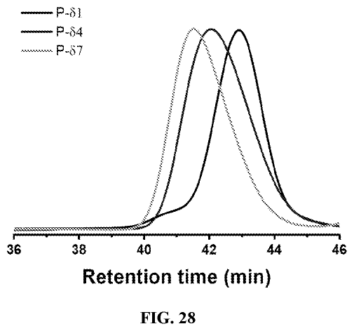

The recovery of the virgin-quality pure δ-lactone monomers enabled reuse for synthesizing new Pδ polymers with the same or different molecule architecture and molecular weight (FIGS. 17-18). FIG. 4E, panels i-iii demonstrated that the v-δ1 tensile samples were depolymerized into monomers, which were then used for the v-δ1 magnetic composite. Since the matrix can completely depolymerize into liquid monomers, and the solid additives or fillers can be easily separated. The magnetic composite was depolymerized again at the end of use and the magnetic particles can be reused (FIG. 4E, panel iv). Thus, the inherent value of the Pδ vitrimer waste could be maximized with the successful demonstration of a “polymer-monomer-polymer” closed-loop life cycle.

### CONCLUSION

Deterioration of thermal and mechanical properties after cycles of reprocessing is generally a major bottleneck for reprocessing and recycling of polymers. To address this end-of-use issue, depolymerizing to recover the original reusable feedstock with a closed-loop life cycle is a promising strategy to maximize the value of vitrimer polymers. We have presented this concept with vitrimers synthesized with natural-derived δ-lactone monomers and acetal dynamic bonds. The Pδ vitrimers, prepared in a facile and scalable approach, can not only undergo reprocessing and recycling but also enable recovery of 85 to 90 wt % of the vitrimers back to the original monomers. We also demonstrated a range of applications of the Pδ vitrimers that could be used as a sustainable replacement for PDMS. The Pδ vitrimers also have the desirable merits of reprocessing and healing that do not exist in PDMS.

### Experimental Section

### Materials

δ-Hexalactone (δ-1), δ-Nonalactone (δ-4), δ-Dodecalactone (δ-7), glycerol, diphenyl phosphate (DPP), triethylamine (TEA) and 1,4-Cyclohexanedimethanol divinyl ether and anhydrous isopropyl alcohol (IPA) were all purchased from Sigma-Aldrich (St. Louis, MO). Monomers and glycerol were dried with a molecular sieve and kept in a nitrogen atmosphere.

Synthesis of Poly(δ-lactone) Triol (Pδ)

The bulk ring-opening polymerizations were performed on a scale of 10 g monomer. The monomer (10 g), the initiator (glycerol) and the catalyst DPP were added into a 20 ml glass vial with a constant molar ratio [monomer]:[initiator]:[DPP] of 12:1:0.12. The reaction was conducted for 48 hours at room temperature with stirring under a nitrogen atmosphere in a glove box.

### Synthesis of Pδ Vitrimers

Crosslinked Pδ vitrimers were synthesized by curing the prepared triol with divinyl ether crosslinker (1,4-Cyclohexanedimethanol divinyl ether) in a molar ratio of [vinyl]:[hydroxyl]=0.9. Under the nitrogen atmosphere glove box, divinyl ether was dropped into synthesized Pδ to mix well with the vortex mixer and then cast in a silicone mold. The mold was then transferred into a nitrogen purged oven and cured for 1 hour at 80° C. The cured sample was soaked in dry IPA with 1 wt % TEA for 6 hours and then dried at room temperature.

### Network Reshaping and Reprocessing

Reshaping and reprocessing of Pδ vitrimers were conducted at 130° C. with a pressed mold for 30 mins (convex lens, imprinting of microchannels, self-healing of actuator). Reprocessing recycles of Pδ vitrimers were hot pressed at 150° C. under the pressure of 5 MPa.

### Depolymerization of Pδ Vitrimers

Pδ vitrimers were sealed with nitrogen in a glass pressure vessel equipped with a magnetic stir bar and depolymerized at 200° C. for at least 1 hour. Monomers were then separated with a fractional vacuum distillation at 80° C.

### Instruments and Characterization

DMA (dynamic mechanical analysis, Q800, TA Instrument) was performed in tensile mode with a constant frequency of 1 Hz and scanned from −60° C. to 60° C. at a heating rate of 10° C./min. Stress relaxation measurements were carried out on the same instrument with a 5% strain after a 20 min equilibrated at target temperature. DSC (differential scanning calorimetry, Q200, TA Instrument) was performed with a heating rate of 10° C./min from −80° C. to 40° C. The uniaxial tension tests and load-unload tests were performed with a universal test machine (Insight 10, MTS Systems Corp.) with a cross-head speed of 5 mm/min. Transparence test was performed on a UV-VIS spectrometer (Evolution 220, Thermo Scientific), and samples were cured between two FEP film with a controlled thickness of 200 μm. Water contact angel was tested with a goniometer (Model 250, Rame-Hart) with a 5 μL water droplet. TGA (thermogravimetric analysis, Q600 SDT, TA Instrument) was performed under nitrogen from 40° C. to 400° C. with a heating rate of 10° C./min. FTIR (fourier-transform infrared spectroscopy, Nicolet iS50 spectrometer, Thermo Fisher Scientific) was measured in absorbance model from 500 to 4000 cm⁻¹. In situ TGA-IR was perform on the same instrument with a TGA-IR module from 40° C. to 400° C. with a heating rate of 10° C./min. Molecular weight of Pδ triols were analyzed using a Tosoh Bioscience EcoSEC Elite-WS HLC-8420GPC system with TSKgel SuperHZ-L columns eluting DMF at a flow rate of 0.40 mL/min. NMR (nuclear magnetic resonance) spectra were recorded on Bruker Avance 400, 500 or 700 MHz instruments and calibrated using residual undeuterated solvent as an internal reference (CHCl3 @7.26 ppm 1H NMR, 77.16 ppm 13C NMR). GC-MS (gas chromatography-mass spectrometry) were performed on Agilent Technologies 8860 GC system/5977B with Triple-Axis Detector.

### Small-Molecule Model Experiments

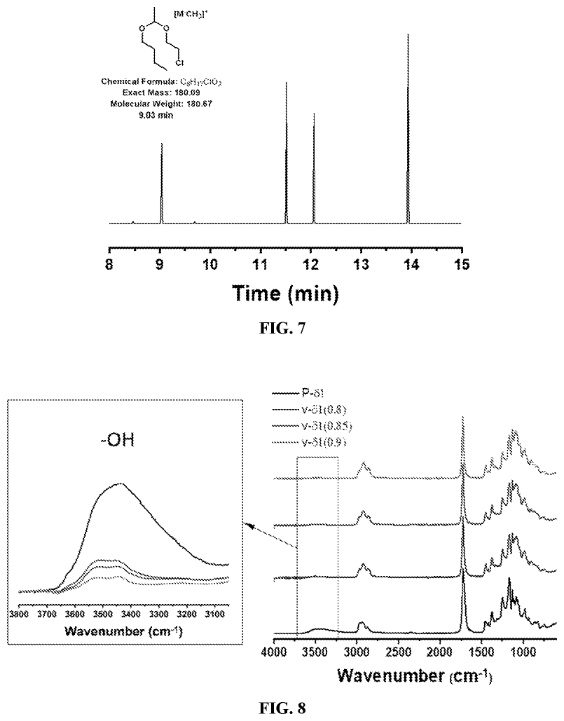

To validate the dynamic acetal exchange reactions, two model acetals were synthesized through the reaction 1 and 2. Equimolar amounts 2-ethylhexanol (Sigma-Aldrich) was mixed with butyl vinyl ether (Sigma-Aldrich) (reaction 1) and 2-chloroethyl vinyl ether (Sigma-Aldrich) (reaction 2) respectively without a solvent in the presence of 0.1 mol % DPP and reacted for 1 hour at 80° C. The model acetals were then confirmed with GC-MS (FIGS. 5-6). The synthesized model acetals were mixed and reacted for 1 hour at 130° C. (reaction 3). The reaction was analyzed with GC-MS and the reference product from acetals exchange reaction was confirmed (FIG. 7).

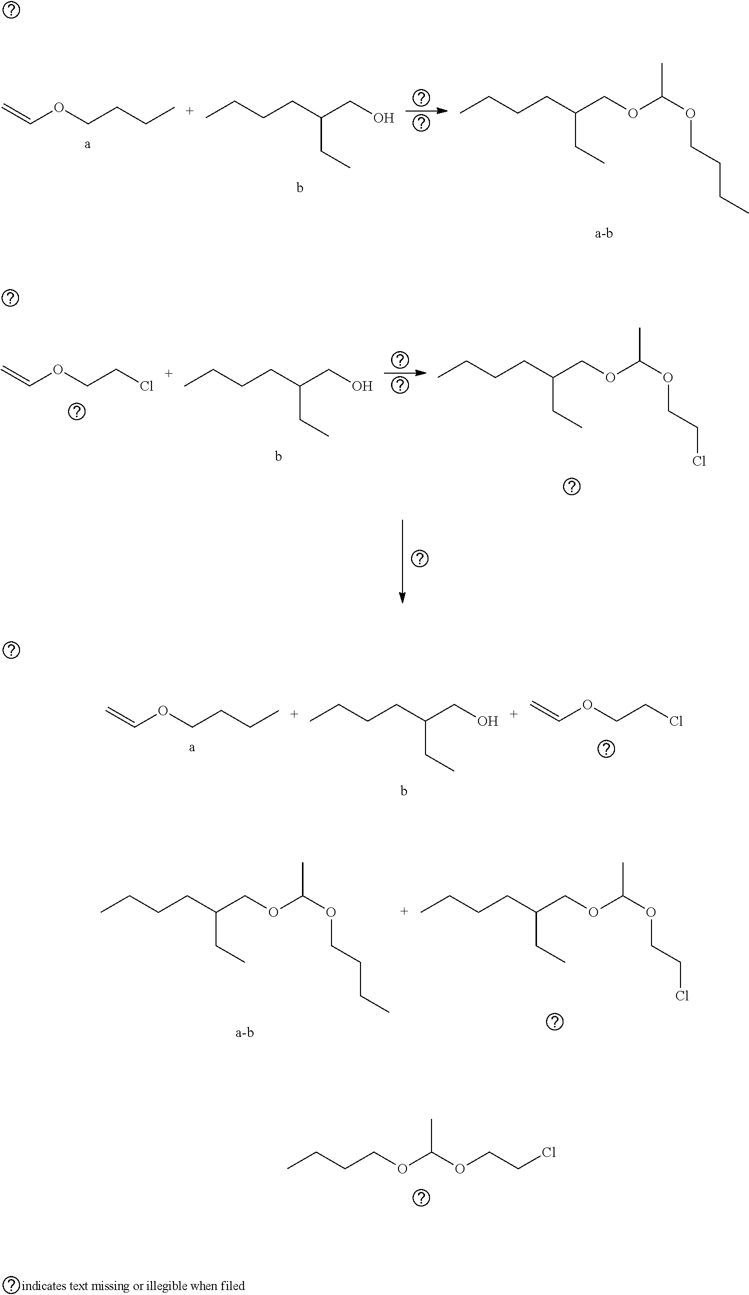

### Swelling Test

Samples were immersed in dry acetone at room temperature for 48 hours. The mass of swollen samples were measured immediately, then dried under vacuum at 80° C. Swelling ratio and gel fraction was calculated from the mass different with equations:

$$Swelling ratio = \frac{Mass after swelling - Mass before swelling}{Mass before swelling} * 100 \%$$

$$Gel fraction = \frac{Mass after drying}{Mass before swelling} * 100 \%$$

### REFERENCES

1. Jambeck, J. R. et al. Plastic waste inputs from land into the ocean. Science 347, 768-771, (2015).
2. Law, K. L. et al. The United States' contribution of plastic waste to land and ocean. Science Advances 6, eabd0288, (2020).
3. MacArthur, E. Beyond plastic waste. Science 358, 843-843, (2017).
4. Borrelle, S. B. et al. Predicted growth in plastic waste exceeds efforts to mitigate plastic pollution. Science 369, 1515-1518, (2020).
5. Fagnani, D. E. et al. 100th Anniversary of Macromolecular Science Viewpoint: Redefining Sustainable Polymers. Acs Macro Lett 10, 41-53, (2021).
6. Worch, J. C. & Dove, A. P. 100th Anniversary of Macromolecular Science Viewpoint: Toward Catalytic Chemical Recycling of Waste (and Future) Plastics. Acs Macro Lett 9, 1494-1506, (2020).
7. Fortman, D. J. et al. Approaches to Sustainable and Continually Recyclable Cross-Linked Polymers. ACS Sustainable Chemistry & Engineering 6, 11145-11159, (2018).
8. Montarnal, D., Capelot, M., Tournilhac, F. & Leibler, L. Silica-like malleable materials from permanent organic networks. Science 334, 965-968 (2011).
9. Guerre, M., Taplan, C., Winne, J. M. & Du Prez, F. E. Vitrimers: directing chemical reactivity to control material properties. Chemical Science 11, 4855-4870, (2020).
10. Yu, S. et al. Catalyst-free metathesis of cyclic acetals and spirocyclic acetal covalent adaptable networks. Acs Macro Lett 9, 1143-1148 (2020).
11. Melchor Baifales, A. J. & Larsen, M. B. Thermal Guanidine Metathesis for Covalent Adaptable Networks. Acs Macro Lett 9, 937-943, (2020).
12. Liu, Z., Yu, C., Zhang, C., Shi, Z. & Yin, J. Revisiting Acetoacetyl Chemistry to Build Malleable Cross-Linked Polymer Networks via Transamidation. Acs Macro Lett 8, 233-238, (2019).
13. Yue, L. et al. Vitrimerization: Converting Thermoset Polymers into Vitrimers. Acs Macro Lett 9, 836-842, (2020).
14. Chen, J.-H., Yuan, W.-Q., Li, Y.-D., Weng, Y.-X. & Zeng, J.-B. Malleable and Sustainable Poly(ester amide) Networks Synthesized via Melt Condensation Polymerization. ACS Sustainable Chemistry & Engineering 7, 15147-15153, (2019).
15. Cromwell, O. R., Chung, J. & Guan, Z. Malleable and self-healing covalent polymer networks through tunable dynamic boronic ester bonds. Journal of the American Chemical Society 137, 6492-6495 (2015).
16. Billiet, S. et al. Triazolinediones enable ultrafast and reversible click chemistry for the design of dynamic polymer systems. Nature chemistry 6, 815-821 (2014).
17. Garcia, J. M. et al. Recyclable, strong thermosets and organogels via paraformaldehyde condensation with diamines. Science 344, 732-735 (2014).
18. Qin, B. et al. Tough and Multi-Recyclable Cross-Linked Supramolecular Polyureas via Incorporating Noncovalent Bonds into Main-Chains. Advanced Materials 32, 2000096, (2020).
19. Scheutz, G. M., Lessard, J. J., Sims, M. B. & Sumerlin, B. S. Adaptable Crosslinks in Polymeric Materials: Resolving the Intersection of Thermoplastics and Thermosets. Journal of the American Chemical Society 141, 16181-16196, (2019).
20. Liang, Y., Kuang, X., Sun, X. & Qi, H. J. in Recent Advances in Smart Self-Healing Polymers and Composites (Second Edition) (eds Guoqiang Li & Xiaming Feng) 483-511 (Woodhead Publishing, 2022).
21. Gewert, B., Plassmann, M. M. & MacLeod, M. Pathways for degradation of plastic polymers floating in the marine environment. Environmental science: processes & impacts 17, 1513-1521 (2015).
22. DiNenno, P. J. SFPE handbook of fire protection engineering. (2008).
23. Shojaeiarani, J., Bajwa, D. S., Rehovsky, C., Bajwa, S. G. & Vahidi, G. Deterioration in the physico-mechanical and thermal properties of biopolymers due to reprocessing. Polymers 11, 58 (2019).
24. Anceschi, A. et al. Identification and Quantitative Determination of Virgin and Recycled Cashmere: a Near-Infrared Spectroscopy Study. ACS Sustainable Chemistry & Engineering 10, 738-745, (2022).
25. Zhang, H., Su, Z. & Wang, X. Starch-Based Rehealable and Degradable Bioplastic Enabled by Dynamic Imine Chemistry. ACS Sustainable Chemistry & Engineering 10, 8650-8657, (2022).
26. Yu, K., Shi, Q., Dunn, M. L., Wang, T. & Qi, H. J. Carbon fiber reinforced thermoset composite with near 100% recyclability. Advanced functional materials 26, 6098-6106 (2016).
27. Li, L., Chen, X. & Torkelson, J. M. Reprocessable polymer networks via thiourethane dynamic chemistry: recovery of cross-link density after recycling and proof-of-principle solvolysis leading to monomer recovery. Macromolecules 52, 8207-8216 (2019).
28. Christensen, P. R., Scheuermann, A. M., Loeffler, K. E. & Helms, B. A. Closed-loop recycling of plastics enabled by dynamic covalent diketoenamine bonds. Nature Chemistry 11, 442-448, (2019).
29. Taynton, P. et al. Repairable woven carbon fiber composites with full recyclability enabled by malleable polyimine networks. Advanced Materials 28, 2904-2909 (2016).
30. Snyder, R. L., Fortman, D. J., De Hoe, G. X., Hillmyer, M. A. & Dichtel, W. R. Reprocessable acid-degradable polycarbonate vitrimers. Macromolecules 51, 389-397 (2018).
31. Zou, Z. et al. Rehealable, fully recyclable, and malleable electronic skin enabled by dynamic covalent thermoset nanocomposite. Science advances 4, eaaq0508 (2018).
32. Zhu, J.-B., Watson, E. M., Tang, J. & Chen, E. Y.-X. A synthetic polymer system with repeatable chemical recyclability. Science 360, 398-403, 98 (2018).
33. Gagliardi, M. & Bifone, A. Ring-opening copolymerization thermodynamics and kinetics of γ-valerolactone/ϵ-caprolactone. PLOS ONE 13, e0199231, (2018).
34. Liu, H. et al. Dynamic Remodeling of Covalent Networks via Ring-Opening Metathesis Polymerization. Acs Macro Lett 7, 933-937, (2018).
35. Schneiderman, D. K. & Hillmyer, M. A. Aliphatic polyester block polymer design. Macromolecules 49, 2419-2428 (2016).
36. Martello, M. T., Burns, A. & Hillmyer, M. Bulk Ring-Opening Transesterification Polymerization of the Renewable δ-Decalactone Using an Organocatalyst. Acs Macro Lett 1, 131-135, (2012).
37. Kamber, N. E. et al. Organocatalytic Ring-Opening Polymerization. Chemical Reviews 107, 5813-5840, (2007).
38. Cederholm, L., Olsen, P., Hakkarainen, M. & Odelius, K. Turning natural δ-lactones to thermodynamically stable polymers with triggered recyclability. Polymer Chemistry 11, 4883-4894 (2020).
39. Schneiderman, D. K. et al. Chemically Recyclable Biobased Polyurethanes. Acs Macro Lett 5, 515-518, (2016).
40. Yan, Q., Li, C., Yan, T., Shen, Y. & Li, Z. Chemically Recyclable Thermoplastic Polyurethane Elastomers via a Cascade Ring-Opening and Step-Growth Polymerization Strategy from Bio-renewable δ-Caprolactone. Macromolecules 55, 3860-3868, (2022).
41. Li, C. et al. Rapid and Controlled Polymerization of Bio-sourced δ-Caprolactone toward Fully Recyclable Polyesters and Thermoplastic Elastomers. Angewandte Chemie International Edition 61, e202201407, (2022).
42. Tang, D., Macosko, C. W. & Hillmyer, M. A. Thermoplastic polyurethane elastomers from bio-based poly (δ-decalactone) diols. Polymer Chemistry 5, 3231-3237 (2014).
43. Li, Q. et al. Fast Reprocessing of Acetal Covalent Adaptable Networks with High Performance Enabled by Neighboring Group Participation. Macromolecules 54, 8423-8434, (2021).
44. Li, Q. et al. Biosourced Acetal and Diels-Alder Adduct Concurrent Polyurethane Covalent Adaptable Network. Macromolecules 54, 1742-1753, (2021).
45. Kirillov, E., Rodygin, K. & Ananikov, V. Recent advances in applications of vinyl ether monomers for precise synthesis of custom-tailored polymers. European Polymer Journal 136, 109872, (2020).
46. Li, Q. et al. Facile catalyst-free synthesis, exchanging, and hydrolysis of an acetal motif for dynamic covalent networks. Journal of Materials Chemistry A 7, 18039-18049, (2019).
47. Moreno, A., Morsali, M. & Sipponen, M. H. Catalyst-Free Synthesis of Lignin Vitrimers with Tunable Mechanical Properties: Circular Polymers and Recoverable Adhesives. Acs Appl Mater Inter 13, 57952-57961, (2021).
48. Naga, N., Hasegawa, K., Nageh, H. & Nakano, T. Synthesis and properties of degradable gels and porous polymers including acetal group in the network structure by addition reaction of multi-functional phenols and divinyl ether compounds. Polymer Bulletin 77, 5631-5645, (2020).
49. El-Atab, N. et al. Soft Actuators for Soft Robotic Applications: A Review. Advanced Intelligent Systems 2, 2000128, (2020).
50. Wu, S. et al. Symmetry-Breaking Actuation Mechanism for Soft Robotics and Active Metamaterials. ACS Appl. Mater. Interfaces 11, 41649-41658 (2019).
51. Montgomery, S. M. et al. Magneto-Mechanical Metamaterials with Widely Tunable Mechanical Properties and Acoustic Bandgaps. Advanced Functional Materials 31, (2021).
52. Ma, C. P. et al. Magnetic Multimaterial Printing for Multimodal Shape Transformation with Tunable Properties and Shiftable Mechanical Behaviors. Acs Appl Mater Inter 13, 12639-12648, (2021).
53. Ma, C. P., Chang, Y. L., Wu, S. & Zhao, R. R. Deep Learning-Accelerated Designs of Tunable Magneto-Mechanical Metamaterials. Acs Appl Mater Inter 14, 33892-33902, (2022).
54. Kuang, X. A. et al. Magnetic Dynamic Polymers for Modular Assembling and Reconfigurable Morphing Architectures. Advanced materials 33, (2021).
55. Ze, Q. J. et al. Soft robotic origami crawler. Sci Adv 8, (2022).
56. Wu, S. et al. Stretchable origami robotic arm with omnidirectional bending and twisting. P Natl Acad Sci USA 118, (2021).
57. Ze, Q. J. et al. Spinning-enabled wireless amphibious origami millirobot. Nature communications 13, (2022).
58. Clark, J., Cheng, J. & Leung, K. Mechanical properties of normal skin and hypertrophic scars. Burns 22, 443-446 (1996).
59. Hayashi, M. & Yano, R. Fair investigation of cross-link density effects on the bond-exchange properties for trans-esterification-based vitrimers with identical concentrations of reactive groups. Macromolecules 53, 182-189 (2019).
60. Tang, J. & Chen, E. Y.-X. Effects of Chain Ends on Thermal and Mechanical Properties and Recyclability of Poly(7-butyrolactone). Journal of Polymer Science Part A: Polymer Chemistry 56, 2271-2279, (2018).
61. Okimoto, Y., Sakaguchi, S. & Ishii, Y. Development of a Highly Efficient Catalytic Method for Synthesis of Vinyl Ethers. Journal of the American Chemical Society 124, 1590-1591, (2002).
62. Tang, D., Macosko, C. W. & Hillmyer, M. A. Thermoplastic polyurethane elastomers from bio-based poly(8-decalactone) diols. Polymer Chemistry 5, 3231-3237, (2014).

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

1. A polymer comprising:
one or more constitutional units derived from a polyol; and
one or more constitutional units derived from an optionally substituted lactone;
wherein the polymer is at least partially crosslinked.

2. The polymer of claim 1, wherein the polymer is a vitrimer.

3. The polymer of claim 1, wherein the one or more constitutional units derived from a polyol comprise a structure of Formula (I): 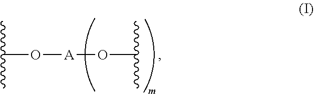
wherein: 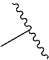
is a point of attachment of the structure of Formula (I) within the polymer;
m is an integer selected from 1 to 5;
A is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-,
R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆ alkyl, C₁-C₆ haloalkyl, C₂-C₆ alkenyl, C₂-C₆ alkynyl, (C₃-C₇ cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆ alkyl, C₁-C₆ haloalkyl, C₂-C₆ alkenyl, C₂-C₆ alkynyl, (C₃-C₇ cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

4. The polymer of claim 3, wherein m is 2.

5. The polymer of claim 3, wherein A is C₁-C₁₂ alkyl.

6. The polymer of claim 3, wherein the one or more constitutional units derived from a polyol comprises 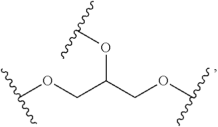 [SMILES: *OCC(CO*)O*]
wherein 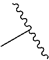
is a point of attachment within the polymer.

7. The polymer of claim 1, wherein one or more constitutional units derived from an optionally substituted lactone comprise a structure of Formula (II): 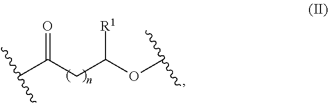
wherein: 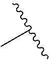
is a point of attachment of the structure of Formula (II) within the polymer;
n is an integer selected from 1 to 4;
R¹ is selected from hydrogen, C₁-C₁₂ alkyl, C₁-C₁₂ haloalkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, and 5- to 10-membered monocyclic or bicyclic heteroaryl, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆ alkyl, C₁-C₆ haloalkyl, C₂-C₆ alkenyl, C₂-C₆ alkynyl, (C₃-C₇ cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆ alkyl, C₁-C₆ haloalkyl, C₂-C₆ alkenyl, C₂-C₆ alkynyl, (C₃-C₂ cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

8. The polymer of claim 7, wherein n is 3.

9. The polymer of claim 7, wherein R¹ is C₁-C₁₂ alkyl.

10. The polymer of claim 1, wherein the one or more constitutional units derived from a polyol and the one or more constitutional units derived from an optionally substituted lactone are directly connected.

11. The polymer of claim 1, comprising one or more constitutional units having the structure: 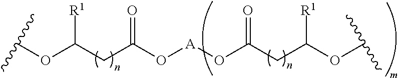
Wherein: 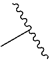
is a point of attachment of the structure of Formula (I) within the polymer;
m is an integer selected from 1 to 5;
n is an integer selected from 1 to 4;
A is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
R¹ is selected from hydrogen, C₁-C₁₂ alkyl, C₁-C₁₂ haloalkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, and 5- to 10-membered monocyclic or bicyclic heteroaryl, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆ alkyl, C₁-C₆ haloalkyl, C₂-C₆ alkenyl, C₂-C₆ alkynyl, (C₃-C₇ cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆ alkyl, C₁-C₆ haloalkyl, C₂-C₆ alkenyl, C₂-C₆ alkynyl, (C₃-C₇ cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

12. The polymer of claim 1, wherein the polymer is at least partially crosslinked with a divinyl ether.

13. The polymer of claim 12, further comprising one or more crosslinking units derived from the divinyl ether.

14. The polymer of claim 13, wherein the one or more crosslinking units comprise a structure of Formula (II): 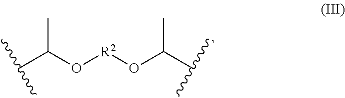
wherein: 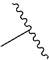
is a point of attachment of the structure of Formula (III) within the polymer;
R² is selected from C₁-C₁₂ alkyl, C₂-C₁₂ alkenyl, C₂-C₁₂ alkynyl, C₃-C₆ cycloalkyl, 3- to 8-membered monocyclic or bicyclic heterocycle, 6- to 10-membered monocyclic or bicyclic aryl, 5- to 10-membered monocyclic or bicyclic heteroaryl, and a polyether, or a combination thereof, each of which may be optionally substituted with one or more groups selected from Z as allowed by valency;
Z is independently selected at each occurrence from hydrogen, halo, nitro, cyano, azido, oxo, C₁-C₆ alkyl, C₁-C₆ haloalkyl, C₂-C₆ alkenyl, C₂-C₆ alkynyl, (C₃-C₆ cycloalkyl)(C₀-C₃ alkyl)-, (3- to 8-membered monocyclic or bicyclic heterocycle)-(C₀-C₃ alkyl)-, (6- to 10-membered monocyclic or bicyclic aryl)-(C₀-C₃ alkyl)-, (5- to 10-membered monocyclic or bicyclic heteroaryl)-(C₀-C₃ alkyl)-, R^{x}O—(C₀-C₃ alkyl)-, R^{x}S—(C₀-C₃ alkyl)-, (R^{x}R^{y}N)—(C₀-C₃ alkyl)-, R^{x}O—C(O)—(C₀-C₃ alkyl)-, R^{x}S—C(O)—(C₀-C₃ alkyl)-, (R^{x}R^{y}N) C(O)—(C₀-C₃ alkyl)-, R^{x}O—S(O)₂—(C₀-C₃ alkyl)-, (R^{x}R^{y}N) S(O)₂—(C₀-C₃ alkyl)-, R^{z}C(O)—O—(C₀-C₃ alkyl)-, R^{z}C(O)—(R^{x}N)—(C₀-C₃ alkyl)-, R^{z}S(O)₂—O—(C₀-C₃ alkyl)-, R^{z}S(O)₂—(R^{x}N)—(C₀-C₃ alkyl)-, R^{z}C(O)—(C₀-C₆ alkyl)-, R^{z}S(O)—(C₀-C₃ alkyl)-, and R^{z}S(O)₂—(C₀-C₃ alkyl)-;
R^{x} and R^{y} are independently selected at each occurrence from hydrogen, C₁-C₆ alkyl, C₁-C₆ haloalkyl, C₂-C₆ alkenyl, C₂-C₆ alkynyl, (C₃-C₇ cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-; and
R^{z} is independently selected at each occurrence from hydrogen, halo, C₁-C₆ alkyl, C₁-C₆ haloalkyl, C₂-C₆ alkenyl, C₂-C₆ alkynyl, (C₃-C₇ cycloalkyl)-(C₀-C₃ alkyl)-, (4- to 6-membered heterocycle)-(C₀-C₃ alkyl)-, (5- to 10-membered monocyclic or bicyclic aryl)-(C₀-C₃ alkyl)-, (5- to 10-membered monocyclic or bicyclic heteroaryl)-(C₀-C₃ alkyl)-, —OR^{x}, —SR^{x}, and —NR^{x}R^{y}.

15. The polymer of claim 14, wherein R² is selected from C₁-C₁₂ alkyl, C₃-C₆ cycloalkyl, and 6- to 10-membered monocyclic or bicyclic aryl, or a combination thereof.

16. The polymer of claim 14, wherein R² is

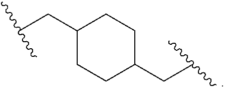 [SMILES: *CC1CCC(C*)CC1]

17. A polymer formed from:
one or more monomers comprising a polyol; and
one or more monomers comprising an optionally substituted lactone;
wherein the polymer is at least partially crosslinked.

18-34. (canceled)

35. An article comprising a polymer of claim 1.

36. (canceled)

37. A method of synthesizing a polymer comprising:
reacting a polyol and an optionally substituted lactone to form a polylactone; and
crosslinking the polylactone to form the polymer.

38-55. (canceled)

56. A polymer prepared by the method of claim 37.
